(19) United States
(12) Patent Application Publication
(10) Pub. No.: US 2025/0248434 A1
(43) Pub. Date: Aug. 7, 2025

(54) AUTOMATED BREADING MACHINE

(71) Applicant: CFA PROPERTIES, INC., Atlanta, GA (US)

(72) Inventors: William Brandon Goodwin, Decatur, GA (US); Robert Luehrsen, Mooresville, NC (US)

(21) Appl. No.: 19/044,059

(22) Filed: Feb. 3, 2025

Related U.S. Application Data
(60) Provisional application No. 63/627,953, filed on Feb. 1, 2024.

(51) Int. Cl. A23P 20/13; A23L 5/10; A47J 37/12

(52) U.S. Cl. CPC A23P 20/13; A23L 5/11; A47J 37/1295

(57) ABSTRACT

Embodiments of the present disclosure relate to systems and methods for holding food products. An example system includes a basket comprising a bottom surface extending between a first sidewall and a second sidewall of the basket. The bottom surface may be rotatable about a first axis extending between the first sidewall and the second sidewall and configured hold a plurality of food products. The bottom surface may comprise a plurality of voids sized to pass material through the bottom surface and oppose movement of the plurality of food products through the bottom surface. The bottom surface may further comprise a locking mechanism configured to prevent rotation of the bottom surface about the first axis in an engaged configuration. The system may include a member configured to transition the locking mechanism from the engaged configuration to a disengaged configuration to enable rotation of the bottom surface about the first axis.

### CROSS REFERENCE TO RELATED APPLICATIONS

This application claims the benefit of and priority to U.S. Application No. 63/627,953, filed Feb. 1, 2024, entitled “AUTOMATED BREADING MACHINE,” the disclosure of which is incorporated herein by reference in its entirety.

### TECHNICAL FIELD

This application generally relates to systems and processes for improving efficiency, consistency, and throughput of breading and frying processes.

### BACKGROUND

In quick-service restaurants (QSRs), fried food products are typically breaded onsite or obtained pre-breaded from a distribution center. Breading generally refers to coating a food product in a compound prior to achieve a desired coating texture upon frying the breaded food product. Pre-breaded products are historically associated with lower flavor and texture quality and, resultingly, QSRs may opt to bread food products onsite immediately prior to frying. This has historically been achieved by placing food products into a liquid wash (e.g., egg, milk, cream, and/or the like) followed by manual application a breading compound against the washed food products to form a coating layer. For example, a chicken filet may be coated in a milk wash and pressed by hand into a tub of breadcrumbs such that the breadcrumbs adhere to the milk wash and form a layer along the chick filet. However, such approaches may result in uneven coating of food products, which may cause inconsistency and/or degradation of flavor, texture, cooking times, and/or the like in subsequent frying processes. Additionally, these approaches may reduce the efficiency and throughput of frying processes and, thereby, the ability of the QSR to meet the high-volume, high-frequency demands of the quick-service industry. Thus, QSRs have not yet solved the challenges of efficiently, consistently, and rapidly breading food products.

### BRIEF SUMMARY

Embodiments of the present disclosure relate to apparatuses, devices, systems, and methods for improving breading and frying processes. An example system for holding food products comprises a plurality of sidewalls defining a rectangular shape; a first void within a first sidewall; a second void within a second sidewall opposite the first sidewall, the second void and the first void aligned along an axis extending across the first sidewall and the second sidewall; a bottom surface configured to hold a plurality of food products within the rectangular shape and comprising: a first end and a second end opposite the first end; and a first member protruding from the first end into the first void and a second member protruding from the second end into the second void such that the bottom surface is rotatable about the axis to dispense the plurality of food products form the rectangular shape; at least one of the first sidewall or the second sidewall comprising a locking mechanism configured to transition between an engaged configuration and a disengaged configuration, wherein: in the engaged configuration, the locking mechanism prevents rotation of the bottom surface about the axis; and at least one handle configured to transition the locking mechanism between the engaged configuration and the disengaged configuration.

In some embodiments, the first sidewall comprises a first bracket comprising the first void; and the second sidewall comprises a second bracket comprising the second void. In some embodiments, the first member comprises a slot; the locking mechanism comprises: a plunger configured to transition between a raised position and a lowered position to transition the locking mechanism between the disengaged configuration and the engaged configuration, wherein: in the lowered position, the slot receives the plunger; and in the raised position, the plunger is external to the slot; and the at least one handle is configured to transition the plunger between the raised position and the lowered position. In some embodiments, the locking mechanism further comprises a spring configured to apply a force to the plunger to bias the plunger toward the lowered position. In some embodiments, the at least one handle extends above the plurality of sidewalls. In some embodiments, the system further comprises a second handle extending along the first sidewall; and a third handle extending along the second sidewall, wherein: the second handle and the third handle extend above the plurality of sidewalls. In some embodiments, the system further comprises a pin extending from the at least one handle along the axis, wherein: at least one of the second handle or the third handle comprises a void configured to receive the pin to maintain the at least one handle in the raised position.

In some embodiments, the axis is centrally aligned to the first sidewall and the second sidewall. In some embodiments, at least the bottom surface comprise a plurality of voids to enable movement of a material through the rectangular shape. In some embodiments, at least a subset of the plurality of sidewalls comprise voids to enable movement of a material through the rectangular shape. In some embodiments, the system further comprises a central shaft extending along the bottom surface, wherein the first member and the second member protrude from opposed ends of the central shaft. In some embodiments, the system further comprises a drive motor comprising a drive shaft, wherein: the second member comprises a coupling configured to receive a drive shaft to rotationally couple the bottom surface to the drive motor. In some embodiments, the bottom surface comprises a plurality of slots spaced apart from one another; and a separation distance between respective slots is sized to enable movement of a breading compound through the bottom surface. In some embodiments, the bottom surface comprises: a plurality of rods defining the plurality of slots. In some embodiments, a perimeter of the bottom surface comprises a rubberized gasket. In some embodiments, the breading compound comprises at least one of flour, powdered sugar, paprika, black pepper, chili powder, salt, or baking powder.

In another example, a system for holding food products comprises a basket comprising a bottom surface extending between a first sidewall and a second sidewall of the basket; the bottom surface being rotatable about a first axis extending between the first sidewall and the second sidewall and configured to hold a plurality of food products, wherein the bottom surface comprises: a plurality of voids sized to pass material through the bottom surface and oppose movement of the plurality of food products through the bottom surface; a locking mechanism configured to prevent rotation of the bottom surface about the first axis in an engaged configuration; and a member configured to transition the locking mechanism from the engaged configuration to a disengaged configuration to enable rotation of the bottom surface about the first axis.

In some embodiments, the first axis is positioned along a vertical plane extending parallel to a third sidewall of the basket, the third sidewall being perpendicular to the first sidewall and the second sidewall; the first sidewall comprises a first coupling slot; the second sidewall comprises a second coupling slot positioned opposite the first coupling slot along a second axis, the second axis positioned above the first axis on the vertical plane; and above the bottom surface, the basket further comprises: a second surface configured to accommodate an additional plurality of food products; and the second surface comprising a first coupling member protruding from the second surface into the first coupling slot and a second member protruding from the second surface into the second coupling slot, wherein: the first coupling slot, the second coupling slot, the first coupling member, and the second coupling slot are configured to enable the second surface to pivot about the second axis between at least a substantially lowered vertical position and a substantially horizontal position.

In various embodiments, the present systems for holding food products are utilized in breading processes, frying processes, and/or the like. An example method for frying food products comprises inserting a first basket into a basin to engage a locking mechanism of a first basket, the locking mechanism configured to prevent rotation of a bottom surface of the first basket when engaged; disengaging a locking mechanism of a second basket to enable rotation of a bottom surface of the second basket, the second basket comprising a plurality of food products; and rotating the bottom surface of second basket to dispense the plurality of food products from the second basket into the first basket, the first basket comprising a plurality of voids to pass a material through the first basket.

In some embodiments, the method further comprises passing at least one heated oil from the basin into the first basket to fry the plurality of food products; removing the first basket from the basin; disengaging the locking mechanism of the first basket to enable rotation of the bottom surface of the first basket; and rotating the bottom surface of the first basket to dispense the plurality of food products out of the first basket.

### BRIEF DESCRIPTION OF THE FIGURES

Having thus described the embodiments of the disclosure in general terms, reference now will be made to the accompanying drawings, which are not necessarily drawn to scale, and wherein:

FIG. 1 shows a perspective view of an example breading system in accordance with some embodiments of the present disclosure;

FIG. 2 shows a top view of an example breading system in accordance with some embodiments of the present disclosure;

FIG. 3 shows a perspective view of an example breading system in accordance with some embodiments of the present disclosure;

FIG. 4 shows a perspective view of a portion of an example breading system in accordance with some embodiments of the present disclosure;

FIG. 5 shows a perspective view of a portion of an example breading system in accordance with some embodiments of the present disclosure;

FIG. 6 shows a perspective view of a portion of an example breading system in accordance with some embodiments of the present disclosure;

FIG. 7 shows a perspective view of a portion of an example breading system in accordance with some embodiments of the present disclosure;

FIG. 8 shows a perspective view of an example breading basket in accordance with some embodiments of the present disclosure;

FIG. 9 shows a right-side view of an example breading basket in accordance with some embodiments of the present disclosure;

FIG. 10 shows a left-side view of an example breading basket in accordance with some embodiments of the present disclosure;

FIG. 11 shows a left-side view of an example breading basket in accordance with some embodiments of the present disclosure;

FIG. 12 shows a top view of an example breading basket in accordance with some embodiments of the present disclosure;

FIG. 13 shows a top view of an example breading basket configured for de-clumping in accordance with some embodiments of the present disclosure;

FIG. 14A shows a bottom view of an example breading basket in accordance with some embodiments of the present disclosure;

FIG. 14B shows a bottom view of an example breading basket configured for de-clumping in accordance with some embodiments of the present disclosure;

FIG. 15 shows a front view of an example breading basket in accordance with some embodiments of the present disclosure;

FIG. 16 shows a back view of an example breading basket in accordance with some embodiments of the present disclosure;

FIG. 17 shows an example sequence of inserting a breading basin into a breading system in accordance with some embodiments of the present disclosure;

FIG. 18 shows an example sequence of inserting a breading basket into a breading basin in accordance with some embodiments of the present disclosure;

FIG. 19 shows an example sequence of operatively connecting a drive motor to a central shaft of a bottom surface of a breading basket in accordance with some embodiments of the present disclosure;

FIG. 20 shows an example sequence of breading food products using a breading system in accordance with some embodiments of the present disclosure;

FIG. 21 shows an example sequence of breading food products using a breading in accordance with some embodiments of the present disclosure;

FIG. 22 shows an example sequence for isolating clumps of breading compound from a breading basin in accordance with some embodiments of the present disclosure;

FIG. 23 shows an example breading basin in accordance with some embodiments of the present disclosure;

FIGS. 24A-B show an example frame, breading basins, and breading baskets in accordance with some embodiments of the present disclosure;

FIG. 25 shows an example frame, breading basins, and breading baskets in accordance with some embodiments of the present disclosure;

FIG. 26 shows an example frame, breading basin, and breading basket in accordance with some embodiments of the present disclosure;

FIG. 27 shows an example an example drive motor and linear actuator in accordance with some embodiments of the present disclosure;

FIG. 28 shows an example control panel in accordance with some embodiments of the present disclosure;

FIG. 29 shows an example breading basket in accordance with some embodiments of the present disclosure;

FIG. 30 shows an example breading sequence in accordance with some embodiments of the present disclosure;

FIG. 31 shows an example sequence for removing clumps from a volume of breading compound in accordance with some embodiments of the present disclosure;

FIG. 32 shows a perspective view of an example breading system in accordance with some embodiments of the present disclosure;

FIG. 33 shows a perspective view of an example breading system in which a portion of the breading system is omitted to enable illustration of additional aspects;

FIG. 34 shows a perspective view of example breading baskets in accordance with some embodiments of the present disclosure;

FIG. 35 shows a left-side view of example breading baskets in accordance with some embodiments of the present disclosure;

FIG. 36 shows a perspective view of an example frying basket in accordance with some embodiments of the present disclosure;

FIG. 37 shows a front view of an example frying basket in accordance with some embodiments of the present disclosure;

FIG. 38 shows a top view of an example frying basket in accordance with some embodiments of the present disclosure;

FIG. 39 shows a diagram an example breading basket and an example frying basket in accordance with some embodiments of the present disclosure;

FIG. 40 shows a perspective view of an example frying basket in accordance with some embodiments of the present disclosure;

FIG. 41 shows a left-side view of an example frying basket in accordance with some embodiments of the present disclosure;

FIG. 42 shows a top view of an example frying basket in accordance with some embodiments of the present disclosure;

FIG. 43 shows a bottom view of an example frying basket in accordance with some embodiments of the present disclosure;

FIG. 44 shows a front view of an example frying basket in accordance with some embodiments of the present disclosure;

FIG. 45 shows a back view of an example frying basket in accordance with some embodiments of the present disclosure;

FIG. 46 shows a back view of an example frying basket in accordance with some embodiments of the present disclosure; and

FIG. 47 shows a bottom perspective view of an example frying basket in accordance with some embodiments of the present disclosure.

### DESCRIPTION

In general, various embodiments of the present disclosure provide improved systems for breading food products. For purposes of describing and illustrating exemplary aspects of the breading system, the proceeding description is presented in the context of breading poultry products, such as chicken nuggets. It will be understood and appreciated that such context is provided by way of example and uses of the system in additional contexts, such as with other food products, are contemplated and within the scope of the invention. For example, the present breading systems may be utilized for breading seafood products (e.g., fish, shrimp, squid, and/or the like), vegetable products (e.g., cauliflower, zucchini, peppers, and/or the like), cheese and other dairy products, and/or the like.

In QSRs, chicken nuggets may be prepared for frying by manually pressing breading ingredients against the chicken nuggets. For example, an operator may drop a batch of chicken nuggets into a reservoir of breading compound and manually sift the chicken nuggets through the breading compound to coat each chicken nugget. The operator may transfer the breaded nuggets from the reservoir to a basket for subsequent frying. However, these manual processes may result in uneven breading consistencies due to variations in hand breading techniques across operators. Additionally, manual breading and basket transfer processes may reduce the efficiency and throughput of the chicken nugget frying process.

In various embodiments, the present disclosure provides an improved breading system that increases breading efficiency and consistency. For example, the breading system enables automated coating of food products with a breading compound in a consistent and repeatable manner. In some embodiments, the breading system includes a breading basket comprising a rotatable bottom surface that enables food products to be dropped into and rotated through a volume of breading compound. The bottom surface of the breading basket may be unlocked to enable rotation through a breading basin comprising a reservoir of breading compound. In some embodiments, the bottom surface is coupled to a drive motor such that the bottom surface may be automatically and selectively rotated using the drive motor. In some embodiments, the drive shaft of the drive motor is mounted to a linear actuator such that the drive motor may be coupled and decoupled to and from the breading basket via extension and retraction of the linear actuator. In some embodiments, the bottom surface of the breading basket is relocked following breading processes to facilitate carrying and subsequent frying of breaded food products, which may further improve efficiency of the QSR kitchen environment by eliminating a step of transferring breaded food products from a breading container to a frying basket.

Further, the present disclosure provides an improved frying basket to increase efficiency of dispensing food products into a container, tray, and/or the like following frying. Typical frying baskets require a user to tip or fully invert a basket to dispense food products out of the basket following frying. For example, a user may lift and twist a basket of fried nuggets to dispense the nuggets out of the top of the basket. However, large batch sizes may result in a heavy basket weight, increasing the difficulty and risk of tipping and flipping the basket. For example, some users may be unable to lift and invert a fully loaded basket, thereby reducing efficiency and/or limiting batch volume. Further, the compact environment of QSR kitchens may limit the space available to lift and flip the basket. In various embodiments, the frying basket described herein overcomes these drawbacks by implementing a bottom surface that is rotatable to dispense food products out of the underside of the basket. In doing so, the frying basket may avoid lift-and-flip requirements of existing approaches. In this manner, the frying basket may improve the efficiency and reduce the difficulty of obtaining fried products.

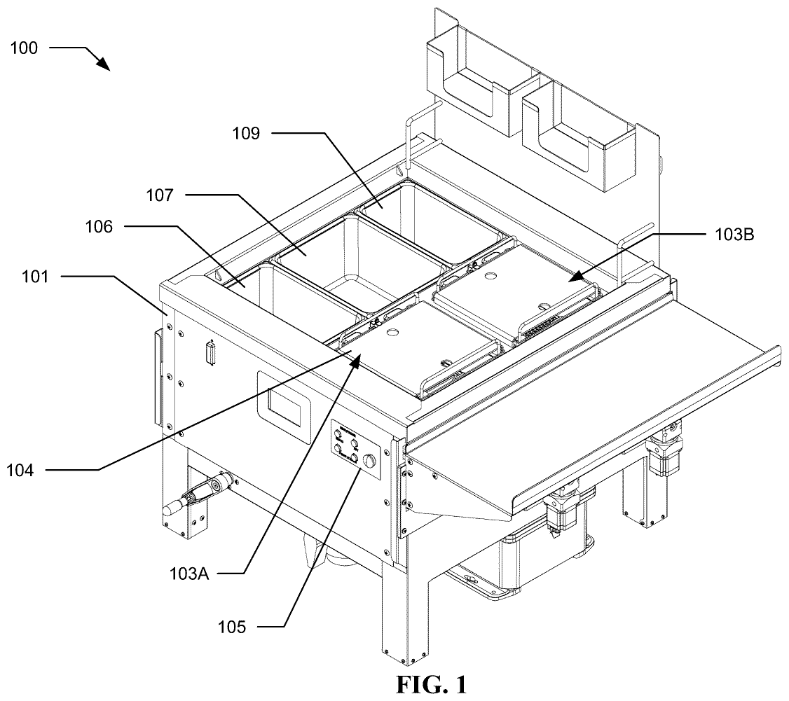

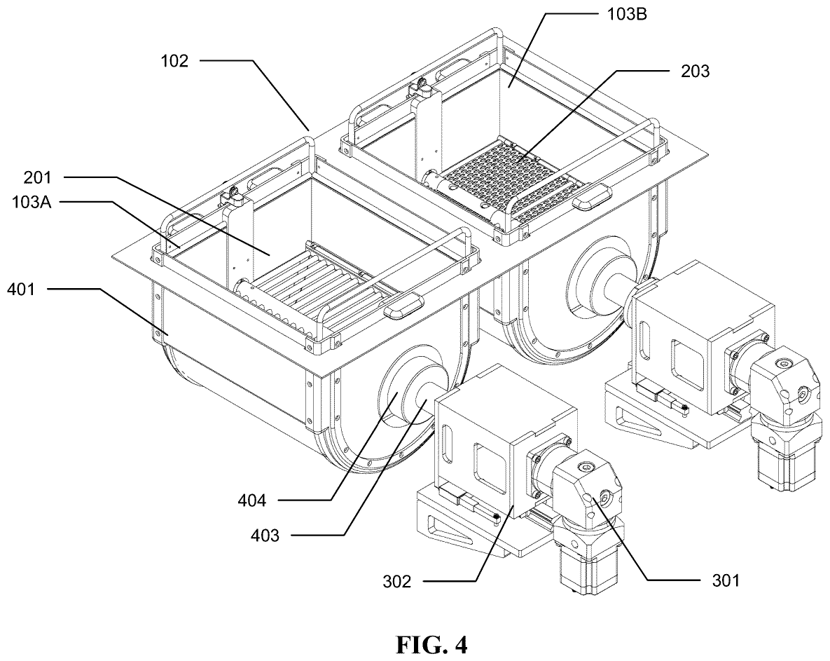

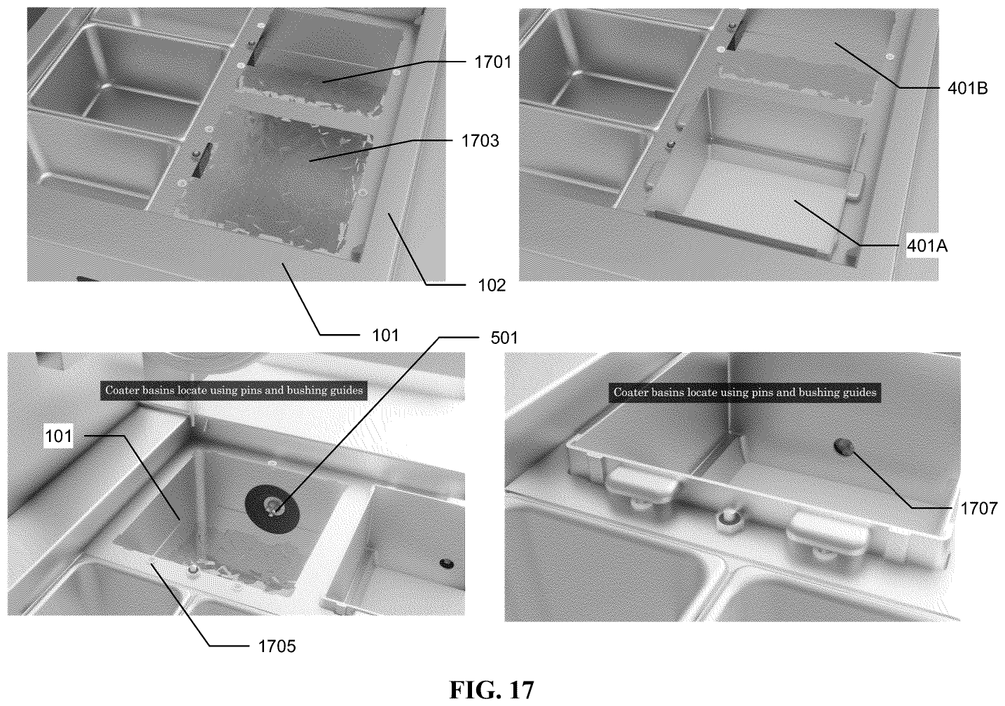

FIG. 1. shows an example breading system 100 for automatically breading food products. In some embodiments, the breading system 100 includes a base 101 that houses elements of the breading system 100 including means for automatically breading food products and means for controlling automated breading of food products as described herein. In some embodiments, the breading system 100 includes one or more breading basins 401 as shown in FIG. 4 and described herein. In some embodiments, a breading basin 401 is configured to contain pre-breading liquids (e.g., milk wash, egg wash, and/or the like), breading compound ingredients, breading compound, and/or the like. In some embodiments, the breading system 100 includes a first breading basin 401 that contains breading compound and a second breading basin 401 that contains milk wash. In some embodiments, the breading system 100 includes one or more breading baskets 103A, 103B within which food products may be coated with breading substances by automated processes described herein. In some embodiments, the breading system 100 includes covers 104 that sheathe the breading baskets to provide a physical barrier between an operator of the breading system 100 and the internal elements of the breading basket. In some embodiments, the cover 104 limits dust or other particulate exposure to the operator during operation of the breading system 100. In some embodiments, the base 101 includes a frame 102 that receives breading basins 401. For example, as further shown in FIGS. 17, 18, 24A-B, and 25, the frame 102 may receive a breading basin 401 and a breading basket 103 may be inserted into the breading basin 401.

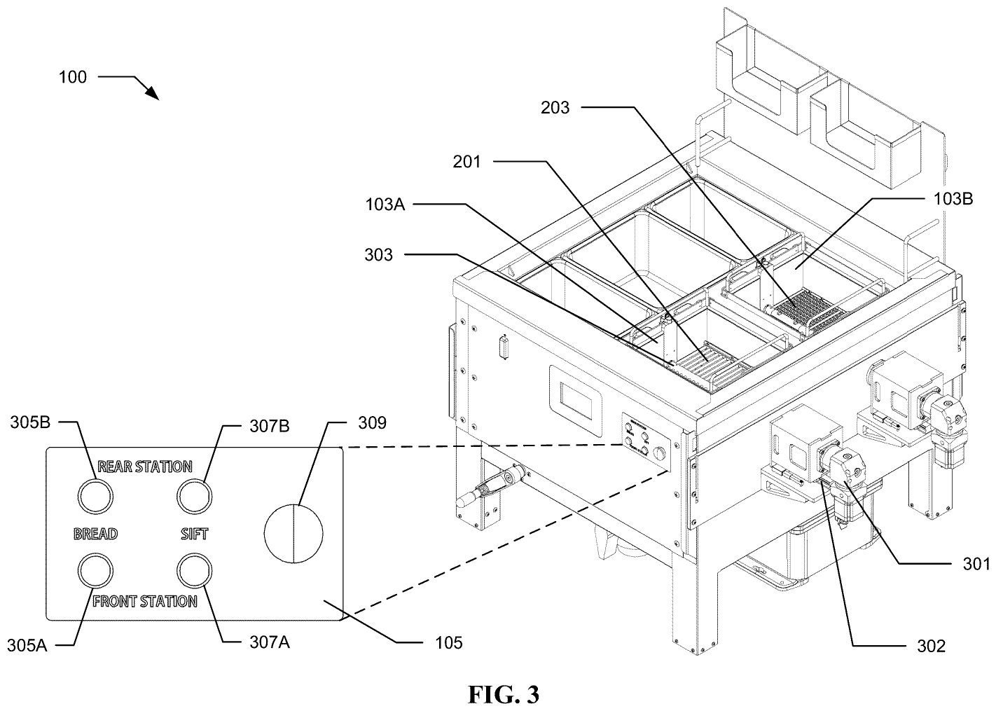

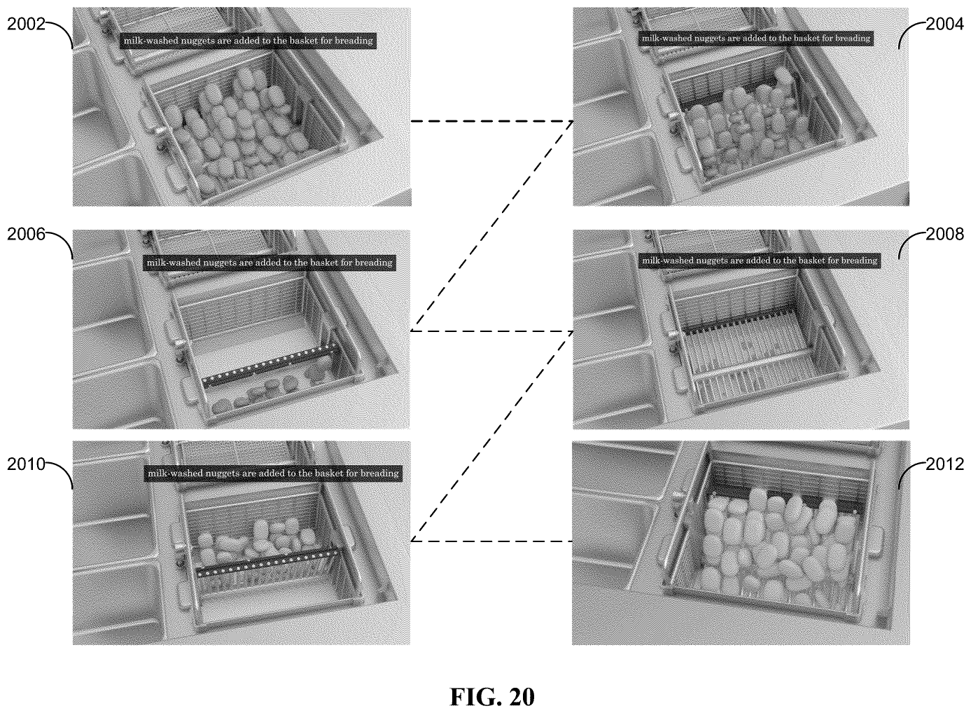

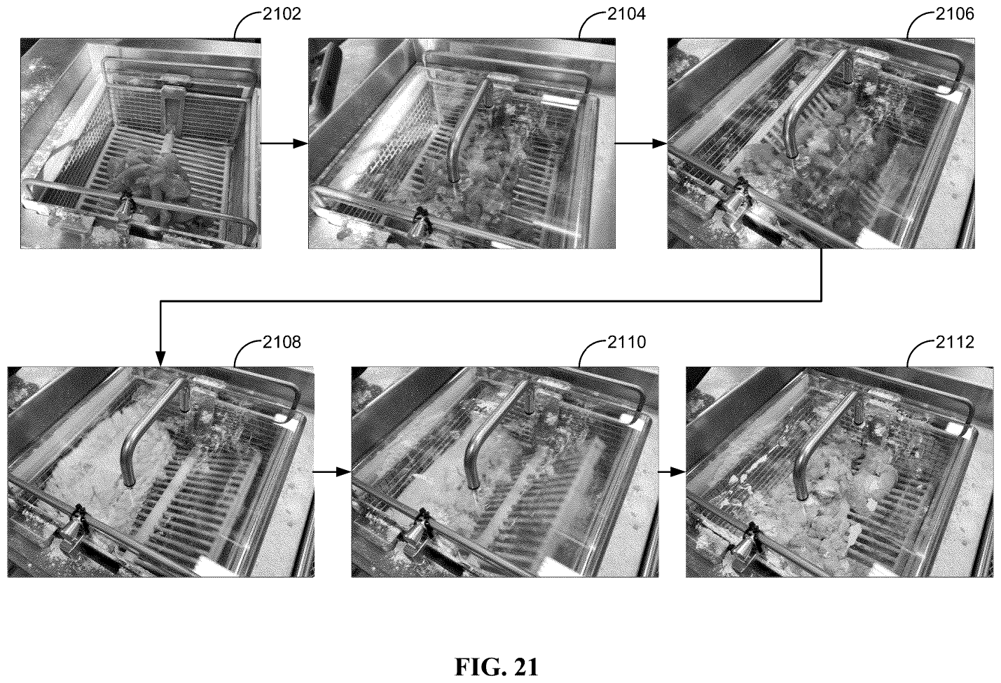

In some embodiments, the breading basket receives food products. For example, chicken nuggets may be coated in a liquid wash and placed into the breading basket. In some embodiments, the breading basket includes a bottom surface comprising voids that are sized to permit movement of breading compound through the bottom surface while preventing translation of food products through the bottom surface. In some embodiments, the bottom surface of the breading basket is rotatable such that food products placed within the breading basket may be lowered into and pushed through a volume of breading compound within the breading basin (sec also FIGS. 20-21). As further shown in FIGS. 3-7 and 19, the breading system 100 may include a drive motor configured to rotate a drive shaft, and a linear actuator configured to forward and reverse translate the drive motor such that the drive shaft couples and decouples to and from the bottom surface of the breading basket. Alternatively, in some embodiments, a bottom portion of the breading basket includes a slot for receiving a drive shaft of the drive motor such that the drive shaft may interface with and couple to the bottom surface of the breading basket. As another alternative, in some embodiments, the breading basket includes a mechanism configured to automatically couple the bottom surface of the breading basket to the drive shaft in response to transition of a rotation locking mechanism of the bottom surface being disengaged.

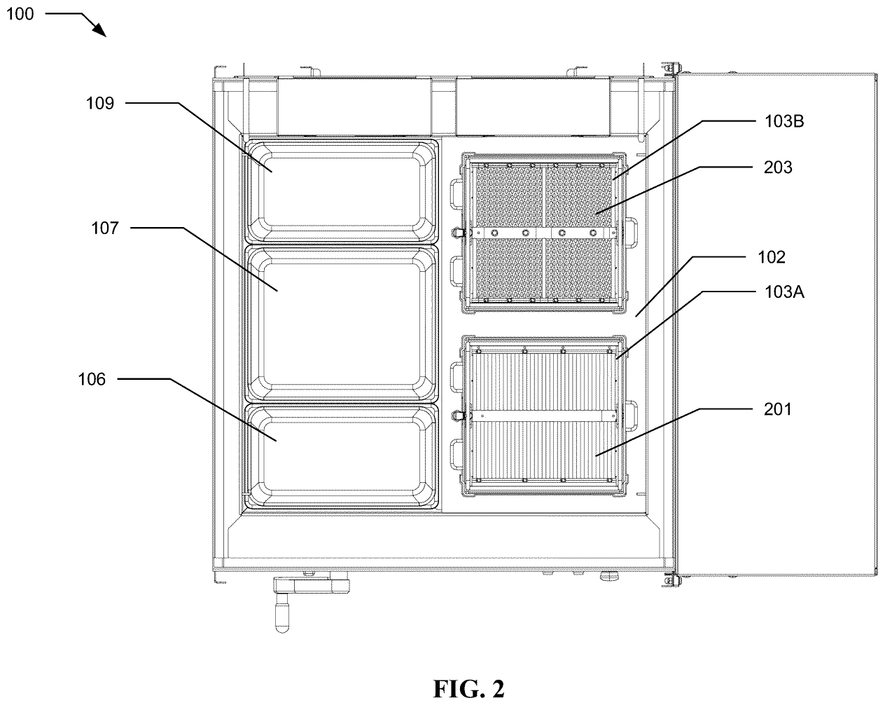

In some embodiments, the breading basket includes a physical identifier, electronic identifier, and/or the like that indicates whether the breading basket is configured for breading food products or sifting through and isolating clumps from breading compound. For example, the breading basket may include a detectable and/or readable identifier that indicates whether a breading basket includes a bottom surface 201 configured for breading or a bottom surface 203 configured for isolating clumps from breading compound (see FIG. 2). In some embodiments, the identifier includes a radio frequency identification (RFID) tag, scannable media (e.g., barcode, QR code, and/or the like), near field communication (NFC) circuit, coloration, and/or the like. Additionally, or alternatively, in some embodiments, breading baskets are identified and differentiated using computer vision (e.g., pattern recognition, object detection, and/or the like). In some embodiments, a breading basket comprising a bottom surface configured for food product breading is referred to as a “tumbler basket,” and a breading basket comprising a bottom surface configured for sifting out and isolating breading compound clumps is referred to as a “sifter basket.” In some embodiments, different breading baskets of same or varying dimensions are used for breading different food products. For example, a first breading basket may be configured for breading chicken nuggets, a second breading basket may be configured for breading chicken strips, and a third breading basket may be configured for breading vegetables.

In various embodiments, the breading system 100 includes a control panel 105 including controls for commanding the drive motor. For example, to perform automated breading, an operator of the breading system 100 may input a command to the control panel 105 that causes the drive motor to complete one or more full rotations and, thereby, cause corresponding rotation of the bottom surface of the breading basket and movement of food products therewithin through the volume of breading compound in the breading basin. As another example, the operator may input a second command to the control panel 105 that causes the drive motor to perform partial clockwise and counterclockwise rotations, thereby causing the bottom surface of the breading basket to undergo corresponding partial rotations in a sifting motion that loosens and dispels excess clumps of breading compound from the food products.

In some embodiments, the control panel 105 executes one or more lockout functions that prevent activation of the breading system 100 based at least in part on one or more parameters. For example, the control panel 105 may include a lockout function that prevents use of the breading system 100 (e.g., including activation of drive motors, linear actuators, and/or the like) in response to a predetermined number of breading cycles (e.g., represented as a drive motor completing a predefined number of rotations, a linear actuator completing a threshold number of extensions and retractions, and/or the like). The lockout function may be cancelled in response to performance of one or more cleaning operations, such as swapping a new breading basin into the base 101 or swapping a new breading basket into a breading basin. For example, the lockout function may be initiated based at least in part on readings from a sensor that is configured to detect instances in which a breading basket is placed a breading basin or removed from the breading basin. As another example, the lockout function may be initiated based at least in part on detecting a threshold number of sequences of extension and retraction of a linear actuator. In another example, the lockout function may be initiated based at least in part on detecting a threshold number of instances of activation and deactivation of a drive motor.

In some embodiments, the control panel 105 disables the lockout function in response to detecting or receiving an input indicative of breading system cleaning. For example, the control panel 105 may detect or receive an input that indicates a breading basket with a bottom surface 201 configured for breading has been swapped for a breading basket having a bottom surface 203 configured for sifting through and isolating clumps from breading compound in the breading basin. In response to detecting placement of the breading basket having the bottom surface 203, the control panel 105 may disable the lockout function to allow an operator to activate the drive motor and rotate the bottom surface 203 through the breading compound in the breading basin.

In some embodiments, the breading system 100 includes preparation basins 106, 107, 109 that receive food products, breading preparation ingredients, and/or the like. For example, the preparation basins 106, 107, 109 may hold pre-or post-washed food products, ingredients for food preparation, liquid washes for washing food products, and/or the like. In various embodiments, food products may be prepped for breading and temporarily stored using the preparation basins 106, 107, 109 prior to being placed into a breading basket. In some embodiments, one or more of the preparation basins 106, 107, 109 include breading compound or breading compound ingredients such that the breading basins may be filled or refilled with breading compound from the preparation basins. In some embodiments, the breading compound may be formed within the breading basin and mixed using an empty breading basket (e.g., a breading basket without food products). For example, ingredients of a breading compound may be dispensed into a breading basin and an empty breading basket may be inserted into the breading basin. The drive motor may be activated to cause rotation of the drive shaft and corresponding rotation of the bottom surface of the breading basket through the breading basin, which may thoroughly mix and distribute the ingredients to form a consistent breading compound.

In an example breading sequence, an operator may fill the breading basin 401 with breading compound. The operator may insert an empty breading basket 103 into the breading basin 401. The breading system 100 may detect that the breading basket 103 is in a locked configuration and, in response, activate a linear actuator to couple a drive motor to the breading basket 103. The operator may coat raw chicken nuggets in a milk wash using the preparation basins 106, 107, 109. The operator may transfer the washed chicken nuggets into the breading basket 103. Alternatively, the operator may transfer the washed chicken nuggets into the breading basin prior to placing the breading basket into the breading basin. The operator may place a cover 104 over the breading basket. The operator may use a control panel 111 to activate the drive motor, thereby causing the bottom surface of the breading basket to rotate. The rotating bottom surface may lower and push the chicken nuggets into and through the breading compound such that a coating layer forms along surfaces of the chicken nuggets. The drive motor may rotate the bottom surface for a plurality of full or partial rotations in one or more rotation directions until the chicken nuggets are sufficiently breaded. The drive motor may also rotate and counterrotate the bottom surface in alternation to dislodge and release clumps of excess breading compound from the chicken nuggets. For example, the drive motor may perform a “shaker” operation to rapidly rotate and counterrotate the bottom surface to cause clumps of breading compound to dislodge excess from the coated food products, which may reduce a likelihood that food products adhere to each other during frying.

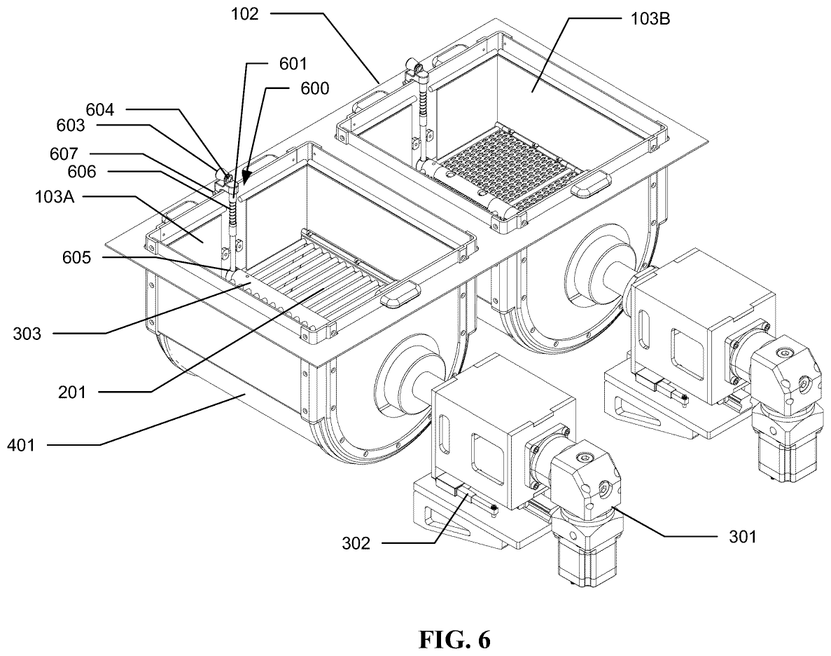

The drive motor may be deactivated automatically or in response to user input. Following drive motor deactivation, the linear actuator may retract to decouple the drive motor from the breading basket. The bottom surface of the breading basket may be relocked in a horizontal orientation to prevent further rotation and enable an operator to safely transport the breaded chicken nuggets using the breading basket. The operator may retrieve the breading basket the containing breaded chicken nuggets out of the breading basin and insert the breading basket directly into a fryer and/or the like to complete the chicken nugget preparation process. Alternatively, in some embodiments, the operator may release a locking mechanism (e.g., a locking mechanism 600 as shown in FIGS. 6, 7, 10, 11, 34, and 35) to enable rotation of the bottom surface of the breading basket such that the breaded food products may be released into a fryer basket.

In some embodiments, the base 101 includes a volume of space beneath the breading basins and preparation basins. In some embodiments, the volume is filled with ice or other cooling media to reduce or maintain temperatures of breading ingredients, breading compounds, food products, and/or the like within one or more desired temperature ranges. For example, the base 101 may include an ice bath beneath the preparation basins and breading basins that maintains a cool environment within the breading system 100.

FIG. 2 shows a top view of an example breading system 100. The example breading system 100 shown omits the covers 104 shown in FIG. 1 to permit view and description of other elements of the system. As shown the breading system 100 may include breading baskets 103A, 103B and preparation basins 106, 107, 109. In some embodiments, the breading basket 103A shown in FIG. 2 includes a bottom surface 201 configured for breading food products. In some embodiments, the bottom surface 201 includes rows of slots sized such that breading compound may pass through the bottom surface 201 while food products are blocked from passing through the bottom surface 201. In some embodiments, one or more portions of the perimeter of the bottom surface of the breading basket include a rubberized gasket configured to reduce the gap between the basin and the surface in order to reduce the likelihood of clogging. For example, the outer edges of the bottom surface 201 may include rubberized gaskets. In various embodiments, as the bottom surface 201 rotates within the breading basin, the bottom surface 201 directs food products through a volume of breading compound. The breading compound may contact and adhere to the surfaces of the food products, thereby forming a breading layer such that the food product may be subsequently fried via placement of the breading basket (or a frying basket that receives the breaded food products) into heated oil. In some embodiments, the breaded food products are released from the breading basket onto one or more baking surfaces (e.g., trays, containers, and/or the like) to facilitate subsequent baking of the breaded food products. In some embodiments, the breading products are released into a container and subsequently placed into a freezer or other cold storage environment.

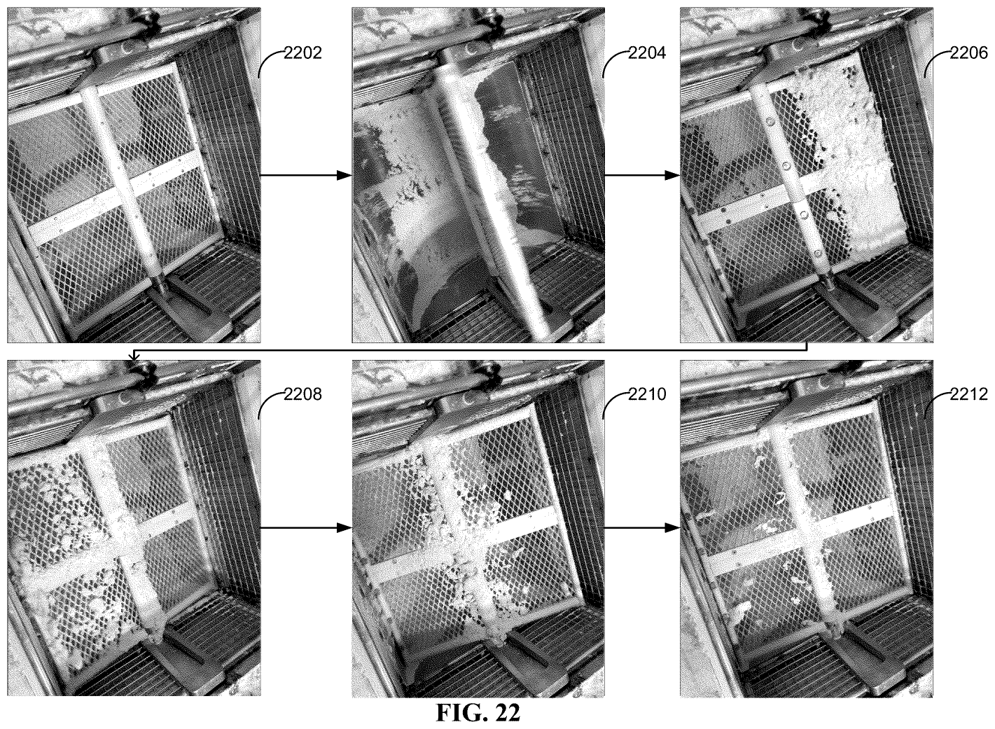

In some embodiments, the breading basket 103B includes a bottom surface 203 configured for isolating clumps from a volume of breading compound within the breading basin. In some embodiments, the bottom surface 203 comprises a plurality of voids that embody a filter screen. For example, as shown in FIG. 22, the bottom surface 203 may embody a mesh filter that may be rotated through a volume of breading compound to collect and isolate clumps. In various embodiments, the voids of the bottom surface 203 comprise dimensions such that breading compound ingredients beneath a threshold particle size may pass through the bottom surface 203 while clumps of breading compound that exceed the threshold particle size are prevented from passing through the bottom surface 203. In some embodiments, via rotation of the drive motor, the bottom surface 203 is rotated through the breading basin to contact and collect clumps of breading compound into the breading basket. For example, between a threshold number of breading processes using the breading basket 103A, the breading basket 103B may be swapped into the breading basin and the bottom surface 203 rotated through the remaining volume of breading compound to collect and isolate clumps. The bottom surface 203 may be locked into place within the breading basket 103B, and the breading basket 103B may be removed from the breading basin for emptying.

FIG. 3 shows a perspective view of an example breading system 100. The example breading system 100 shown omits the covers 104 and a preparation surface shown in FIG. 1 to permit view and description of other elements of the system. As shown, the breading system 100 may include one or more drive motors 301 and linear actuators 302. In various embodiments, the drive motor 301 includes a drive shaft configured to couple to a central shaft 303 of a bottom surface of a breading basket. For example, the breading basket 103A may include a bottom surface 201 including a central shaft 303. As another example, the breading basket 103B may include a bottom surface 203 including a central shaft 303. In some embodiments, the drive motor 301 is configured to rotate in response to commands provided to a control panel 105. In some embodiments, the control panel 105 includes input devices for controlling the breading system 100. The input devices may include buttons, switches, joysticks, touch panels, dials, sliders, torque controllers, and/or the like. In some embodiments, the control panel 105 includes a first set of input devices for controlling a first drive motor 301 and a second set of input devices for controlling a second drive motor 301. The first and second drive motors may be coupled to a first and second breading basket, respectively, such that multiple batches of food products may be breaded simultaneously or asynchronously using the breading system 100. In some embodiments, a drive motor includes a torque sensor configured to measure torque at the drive shaft. The control panel may include one or more displays, readouts, and/or the like on which motor torque may be displayed. In some embodiments, the control panel includes one or more input devices configured to adjust parameters of breading operations based at least in part on motor torque, batch size, and/or the like. For example, torque sensors on the drive motor may be used to manually or automatically adjust a breading sequence for different sized batches of food products.

In some embodiments, the breading system 100 includes one or more computer vision sensors (e.g., cameras, infrared detectors, and/or the like) and performs one or more computer vision techniques to control parameters of breading operations. For example, one or more computer vision techniques may be used to estimate an amount of food product introduced to the breading basin or breading basket. As another example, one or more computer vision techniques may be used to estimate an amount of breading compound remaining in a breading basin. In still another example, one or more computer vision techniques may be used to estimate breading compound coverage on food products to enable the breading system 100 to determine whether the products are fully breaded, fully sifted, and/or the like. In some embodiments, the one or more parameters of the breading operation include rotation direction, rotation angle, counterrotation frequency, rotation speed, rotation acceleration, and/or the like. In one example, in response to determining that food products are not fully breaded following a first breading sequence, the breading system 100 may initiate a second breading sequence to further rotate the food products through the breading compound. In another example, in response to determining the inserted food products are associated with a particular batch size (e.g., small, medium, large, and/or the like), the breading system 100 may increase or decrease a duration, speed, counterrotation frequency, or other parameter of a breading operation to accommodate the batch size.

In some embodiments, the control panel includes input devices 305A, 305B that are configured to command a respective drive motor 301 to perform a breading operation. In some embodiments, the breading operation includes the drive motor 301 rotating the drive shaft (and, thereby, the bottom surface of a breading basket) in a first direction by a predetermined rotation angle (e.g., 360 degrees, 720 degrees, 1080 degrees, or other suitable value) or for a predetermined time interval (e.g., 10 seconds, 30 seconds, or other suitable value). For example, the input device 305A may embody a button and, in response to an operator pressing the button, the control panel 105 may command the drive motor 301 to rotate the drive shaft continuously in a first direction until the button is no longer depressed. The rotating drive shaft may cause corresponding rotation of the bottom surface 201 of the breading basket 103A via a coupling formed between the drive shaft and the central shaft 303. As another example, in response to an operator providing an input to the input device 305A, the control panel 105 may command the drive motor 301 to complete 1, 2, 3, or any suitable number of complete rotations in a first direction, a second direction opposite the first direction (e.g., sequentially or in alternation), and/or the like. In another example, in response to the input, the control panel 105 may command the drive motor 301 to rotate the drive shaft in a first direction for a predetermined time interval (e.g., potentially followed by counterrotation in a second direction for a second predetermined time interval).

In some embodiments, the control panel 105 includes input devices 307A, 307B that are configured to command a respective drive motor 301 to perform a sifting operation. In some embodiments, the sifting operation includes the drive motor 301 rotating and counterrotating the drive shaft to cause corresponding rotation of the bottom surface of the breading basket in alternating directions. In some embodiments, the sifting operation is performed to detach excess breading compound from food products within the breading basket. For example, the input device 307A may embody a button and, in response to an operator pressing the button, the control panel 105 may command the drive motor 301 to rotate the drive shaft in alternating directions. The central shaft 303 coupled to the drive shaft may rotate and counterrotate such that excess breading compound detaches from breaded food products and falls through the bottom surface 201.

Alternatively, or additionally, in some embodiments, the drive motor 301 is configured to automatically rotate based at least in part on commands from a computing device (not shown). For example, in response to coupling of the drive shaft to the central shaft of the breading basket, a computing device may automatically command the drive motor 301 to rotate the drive shaft for a predetermined number of full and/or partial rotations at one or more predetermined rotation rates. In some embodiments, the control panel 105 includes an input device 309 that, in response to receiving input, causes the control panel 105 to suspend operations of the breading system 100. For example, the input device 309 may embody an emergency stop button and, in response to an operator pressing the button, the control panel 105 may deactivate all drive motors of the breading system 100.

In some embodiments, the control panel 105 includes one or more input devices that adjust speed, acceleration, and/or direction of drive motor rotation. For example, the control panel 105 may include a first, second, and third input device that enable an operator to control, respectively, the rotational speed, acceleration, and direction of the drive motor 301 according to a desired breading operation. Additionally, or alternatively, in some embodiments, the control panel 105 includes a controller that automatically configures parameters of the drive motor 301 according to one or more predefined breading operations. For example, in response to receipt of input at the input device 305A, the controller may automatically activate a drive motor 301 along a predefined sequence of rotation speeds, rotation accelerations, rotation directions, and/or rotation counts or periods according to a predefined breading operation. In some embodiments, the controller includes memory configured to store computer-readable instructions for carrying out one or more breading operations. The computer-readable instructions, when processed by the controller, may cause the controller to activate the drive motor 301 according to a set of predefined parameters.

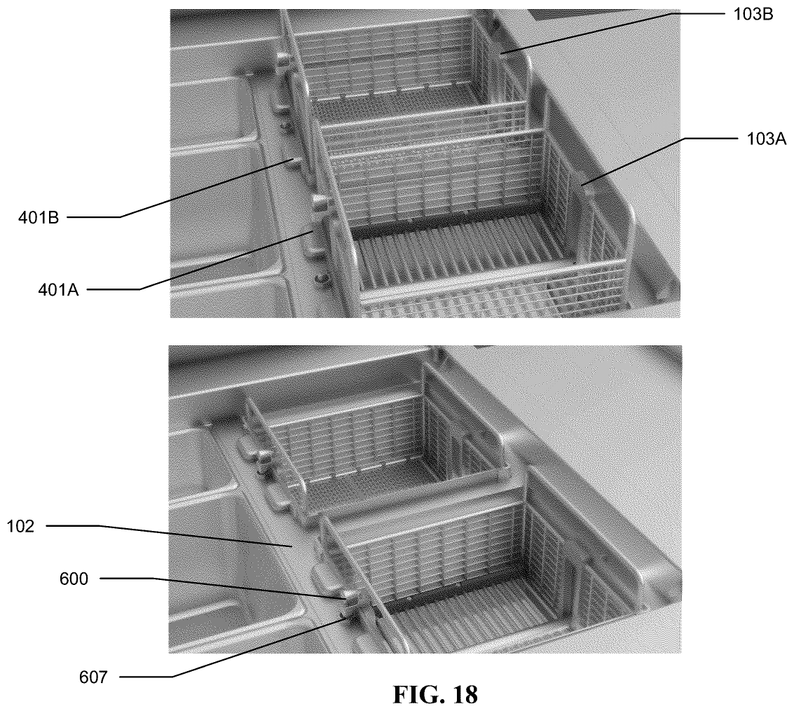

In various embodiments, the linear actuator 302 is configured to forward and reverse translate toward and away from a breading basket disposed within a breading basin. In some embodiments, the drive motor 301 is mounted to the linear actuator 302 such that the position of the drive motor 301 relative to the breading basket is adjustable via the forward and reverse translation of the linear actuator 302. In various embodiments, the linear actuator 302 forward and reverse translates to couple and decouple the drive shaft of the drive motor 301 to and from the central shaft 303 of a breading basket. For example, as shown in FIG. 18, a linear actuator may be activated to extend a drive shaft through a breading basin and mate the drive shaft with a central shaft of the bottom surface of the breading basket (e.g., such that the subsequent rotation of the drive shaft causes corresponding rotation of the bottom surface of the breading basket).

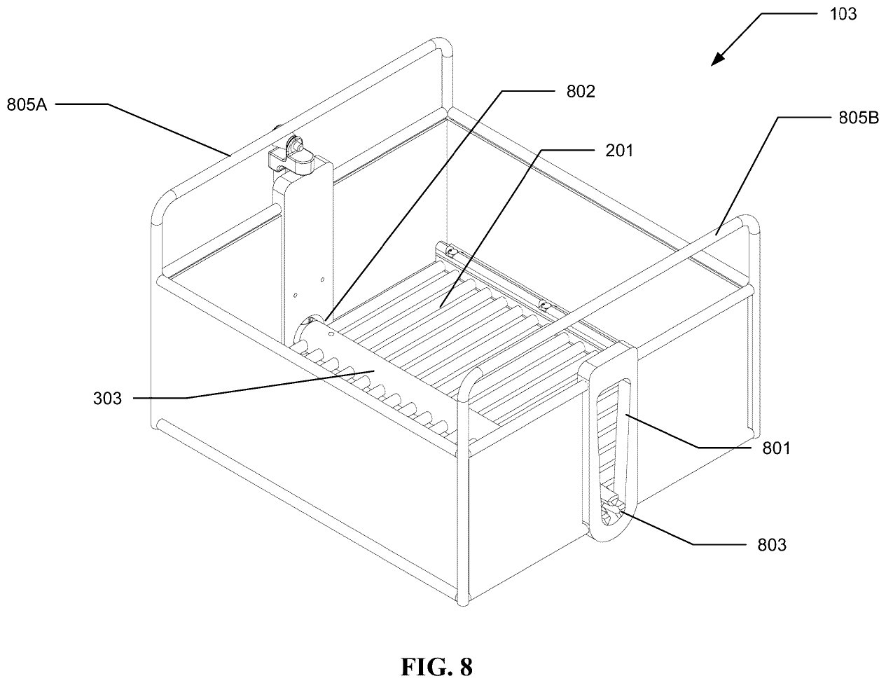

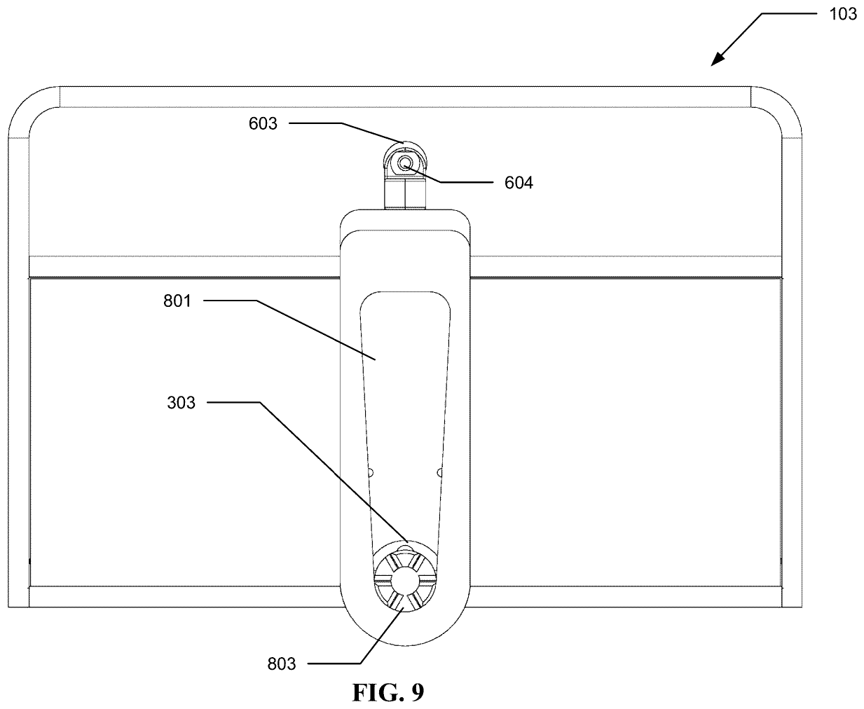

In some embodiments, the linear actuator 302 automatically forward translates in response to insertion of a breading basket into a breading basin. For example, the linear actuator 302 may receive a sensor reading indicative of the insertion and, in response, forward translate to couple the drive motor 301 to the inserted breading basket. In some embodiments, the linear actuator 302 is configured to forward translate in response to receiving a signal that a bottom surface of the breading basket is unlocked such that the bottom surface is free to rotate. For example, a breading basket 103A may be inserted into a breading basin and a locking mechanism of the bottom surface 201 may be disengaged such that the bottom surface 201 is free to rotate about an axis extending longitudinally along the central shaft 303. A sensor may detect disengagement of the locking mechanism and, in response to the detection, the linear actuator 302 may automatically extend to couple the drive shaft of the drive motor 301 to the central shaft 303. Additionally, or alternatively, in some embodiments, the linear actuator 302 is configured to extend and retract in response to commands from the control panel 105. For example, the control panel 105 may include one or more input devices by which an operator may control extension and retraction of the linear actuator to couple and decouple a breading basket from the drive motor 301. In some embodiments, as shown in FIGS. 8 and 9, a wall of the breading basket includes a slot that enables the breading basket to be removed from the breading basin without requiring the linear actuator 302 to remove the drive shaft of the drive motor 301 from the breading basin. For example, at the bottom of the void 801 shown in FIGS. 8-9, the breading basket may further include a slot that enables coupling and decoupling of the bottom surface to and from the drive shaft via lowering and raising of the breading basket into and out of the breading basin. In such embodiments, the linear actuator 302 may be used to translate and reverse translate the drive shaft into and out of the breading basin for loading and unloading of the breading basin during initial setup and cleaning.

FIG. 4 shows a perspective view of a portion of an example breading system. For example, FIG. 4 illustrates embodiments of a frame 102, breading baskets 103A, 103B, linear actuator 302, and drive motor 301. In some embodiments, the breading system includes one or more breading basins 401 that are configured to contain a breading compound. For example, the breading basin 401 may contain a breading compound including flour, powdered sugar, paprika, black pepper, chili powder, salt, and baking powder. In some embodiments, the breading basin 401 includes a curved bottom portion conforms to an angle of rotation of the bottom surface 201 of a breading basket. For example, when rotated by the drive motor 301, the bottom surface 201 of the breading basket 103A may trace an arc of rotation, and the curvature of the bottom portion of the breading basin 401 may conform to the arc of rotation such that edges of the bottom surface 201 pass along the periphery of the bottom portion. In some embodiments, the edges of the bottom surface 201 include elastomeric material configured to contact the bottom portion of the breading basin 401. For example, edges of the bottom surface 201 may include a rubberized gasket configured to reduce a gap between the surface and the breading basin in order to reduce a likelihood of breading compound clogging, food product clogging, and/or the like. Embodiments of the invention may provide a small clearance between the bottom portion of the breading basin 401 and the bottom surface of the breading basket.

In various embodiments, the breading basin 401 includes a void that receives a drive shaft of the drive motor 301. In some embodiments, the breading system includes a shaft housing 403 that includes opposing ends open to the void and the drive motor 301, respectively. In some embodiments, the shaft housing 403 receives the drive shaft of the drive motor 301 through the opposing ends. In some embodiments, the breading basin 401 includes one or more gaskets 404 and/or the like that are configured to seal the breading basin 401 and shaft housing 403.

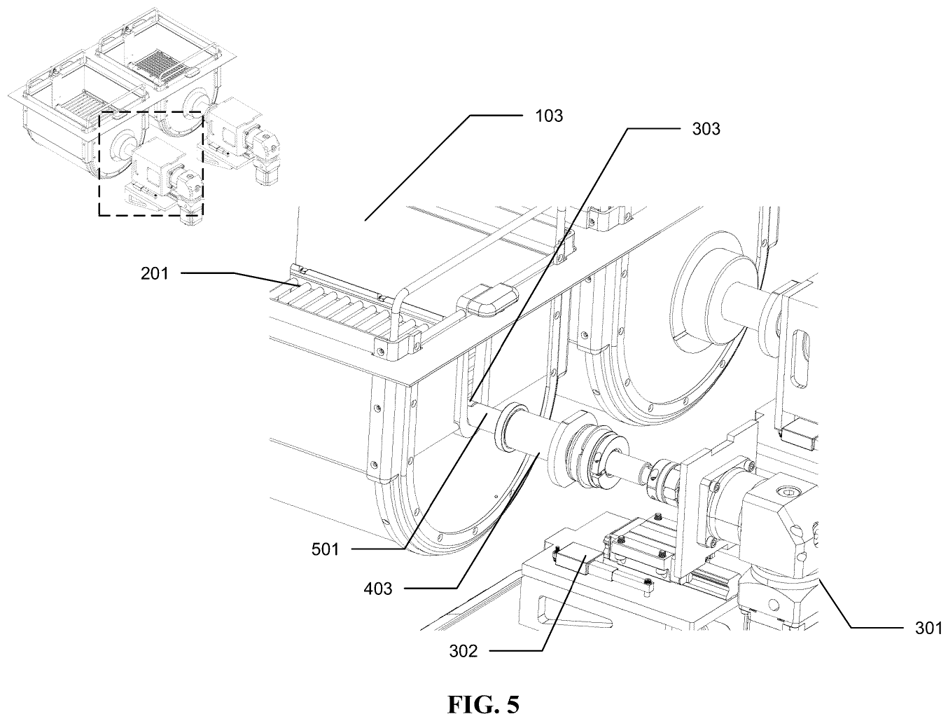

FIG. 5 shows a perspective view of a portion of an example breading system. For example, FIG. 5 illustrates embodiments of a breading basket 103, drive motor 301, and linear actuator 302. In various embodiments, FIG. 5 illustrates the linear actuator 302 in a forward-translated configuration. In some embodiments, in the forward-translated configuration, the drive shaft 501 of the drive motor 301 couples to the central shaft 303 of the bottom surface 201 of the breading basket 103.

FIG. 6 shows a perspective view of a portion of an example breading system. For example, FIG. 6 illustrates embodiments of a frame 102, breading baskets 103A, 103B, breading basin 401, drive motor 301, and linear actuator 302. FIG. 6 omits portions of the breading baskets 103A, 103B for purposes of illustrating and describing additional elements. In some embodiments, the breading basket 103A includes a locking mechanism 600 configured to secure the bottom surface 201 against rotation upon engagement and enable rotation of the bottom surface 201 upon disengagement. FIG. 6 illustrates the locking mechanism 600 in an engaged configuration. In some embodiments, the locking mechanism 600 includes a plunger 601 that may be inserted into and removed from a void 605 of the central shaft 303 to engage and disengage the locking mechanism 600. When inserted into the void 605, the plunger 601 may prevent rotation of the central shaft 303.

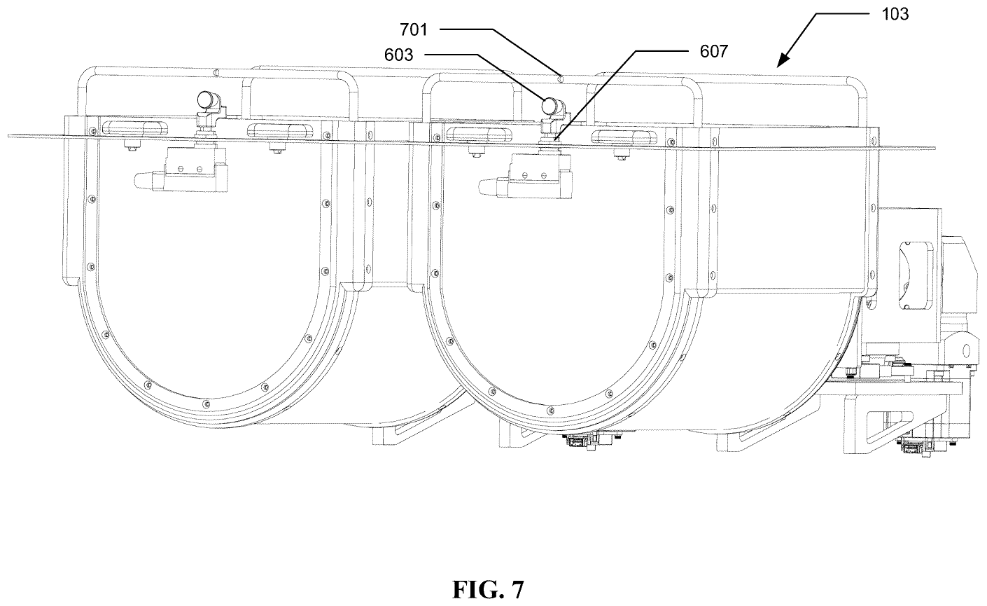

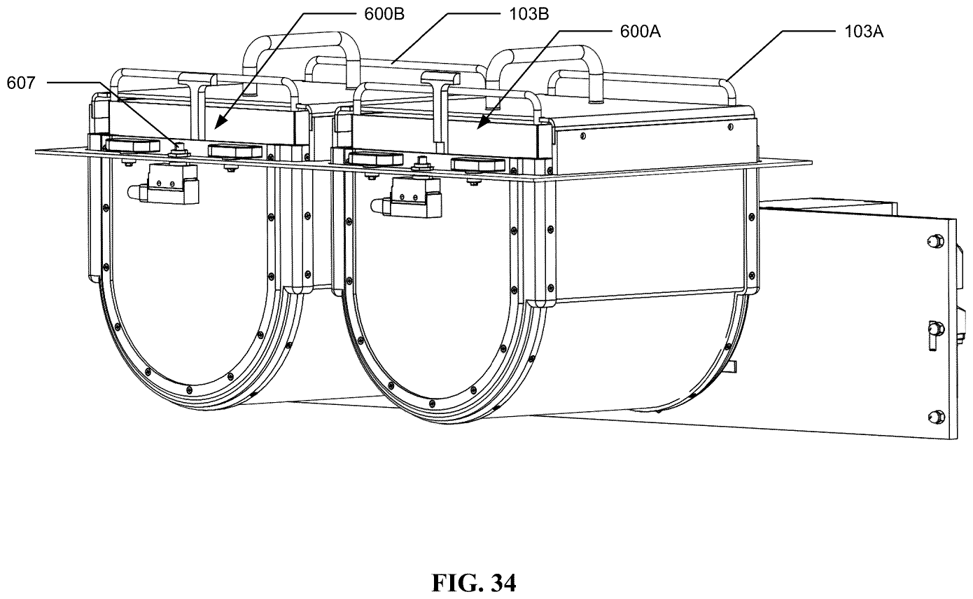

In various embodiments, the locking mechanism 600 includes a member configured to transition the locking mechanism 600 between the engaged configuration and the disengaged configuration to control rotation of the bottom surface 201. For example, the locking mechanism 600 may a handle 603 connected to the plunger 601 such that the plunger 601 may be raised and lowered by an operator using the handle 603. In some embodiments, the handle 603 includes a pin 604 for securing the handle 603 in a raised position by mating the pin 604 with an upper void of the breading basket (not shown, see FIG. 7). In some embodiments, the locking mechanism 600 includes a spring 606 secured between the handle 603 and plunger 601. In some embodiments, the spring 606 biases the plunger 601 toward insertion into the void 605 such that the locking mechanism 600 is biased toward engagement. In some embodiments, the locking mechanism 600 is physically disengaged as the breading basket 103 is lowered into a breading basin. For example, the breading basin 401, frame 102, and/or the like may include a physical catch or other interference mechanism that interfaces with and disengages the locking mechanism 600 as the breading basket 103 is lowered into the breading basin. As another example, the breading basket 103, frame 102, breading basin 401, and/or the like may include a magnetic lock, sensor, and/or the like configured to cause a transition the locking mechanism to a disengaged state as the breading basket is lowered into the breading basin. In some embodiments, as shown in FIGS. 34-45, the handle 603 and plunger 601 are integrally formed such that the plunger embodies a lower portion of the handle 603.

In some embodiments, the frame 102 includes a sensor 607 that detects engagement of the locking mechanism 600. In some embodiments, the sensor 607 embodies a pressure sensor, optical sensor, switch, magnetic sensor, and/or the like that is triggered when the handle 603 is lowered to engage the locking mechanism 600. In some embodiments, a computing device in control of the linear actuator 302 receives readings from the sensor 607. In various embodiments, in response to receiving a reading that indicates the locking mechanism is engaged, the computing device prevents extension of the linear actuator 302. For example, the breading basket 103 may be inserted into the breading basin 401 while the locking mechanism 600 is engaged (e.g., the plunger 601 is lowered into the void 605 of the central shaft 303). The lowered position of the plunger 601 may result in the handle 603 contacting the sensor 607. In response to the contact of the handle 603, the sensor 607 may transmit a signal to the computing device in control of the linear actuator 302 that causes the computing device to determine that the locking mechanism 600 is engaged. In response to the determination, the computing device may disable the linear actuator 302 from extending. Additionally, or alternatively, in some embodiments, the computing device may cause the linear actuator 302 to retract such that the drive shaft of the drive motor 301 decouples from the central shaft 303 of the breading basket 103A. For example, following performance of coating operations using the breading system, the locking mechanism 600 may be engaged via lowering of the plunger 601 via the handle 603. Upon lowering, the handle 603 may contact the sensor 607, which may cause automatic retraction of the linear actuator 302 to decouple the drive motor 301 from the breading basket 103A. Additionally, or alternatively, in some embodiments, in response to the sensor 607 being triggered, the computing device prevents activation of the drive motor. In some embodiments, the breading system 100 includes an actuator configured to engage and disengage the locking mechanism 600 before and after breading operations. For example, the breading system 100 may include an actuator configured to engage the locking mechanism 600 while the drive shaft of the drive motor 301 is decoupled from the breading basket and disengage the locking mechanism 600 in response to coupling of the drive shaft to the bottom surface of the breading basket.

In some embodiments, the sensor 607 generates a reading in response to suspension of contact between the sensor 607 and the handle 603. For example, the handle 603 (and connected plunger 601) may be configured to a raised position such that the handle 603 is out of contact with the sensor 607. The raised position of the handle 603 may correspond to a raised position of the plunger 601 out of the void 605. The sensor 607 may generate a reading (or suspend transmission of a reading) in response to the suspension of contact between the sensor 607 and the handle 603. In some embodiments, in response to the reading, the computing device in control of the linear actuator 302 determines that the locking mechanism 600 is disengaged (e.g., the central shaft 303 may freely rotate). In some embodiments, in response to the determination, the computing device causes the linear actuator 302 to extend such that the drive shaft of the drive motor 301 forward translates into the breading basket 103A and couples to the central shaft 303.

In some embodiments, the control panel of the breading system receives readings from the sensor 607 and/or notifications from the computing device in control of the linear actuator 302. For example, in response to extension of the linear actuator 302, the computing device may cause activation of one or more lights, indicator fields, and/or the like on a control panel of the breading system such that an operator is notified that the drive motor may be activated to rotate the bottom surface 201. As another example, in response to the handle 603 contacting the sensor 607, the control panel may receive a signal that causes the control panel to display an indication that the locking mechanism 600 is engaged and the drive motor is decoupled, which may signal to an operator that the breading basket may be removed from the breading basin.

In some embodiments, the locking mechanism 600 may be automatically engaged to secure the bottom surface of the breading basket against rotation following breading operations. For example, in response to an input to the control panel, the linear actuator 302 may retract to decouple the drive motor from the central shaft 303. The disconnection of the drive shaft from the central shaft 303 may trigger a second mechanism (e.g., switch, linear actuator, and/or the like) to release the handle 603 from a raised position such that the plunger 601 may descend into the void 605, thereby engaging the locking mechanism 600. In some embodiments, the breading basin 401 includes a mechanism, catch, and/or the like that automatically engages the locking mechanism 600 in response to the breading basket being lifted. In some embodiments, the mechanism, catch, and/or the like automatically releases the handle 603 and, thereby, the plunger 601, in response to the breading basket being lifted. For example, as the breading basket is lifted from the breading basin by an operator, a catch may automatically dislodge a pin of the handle 603 from a void such that the spring 606 drives the plunger 601 into the void 605 of the central shaft 303, thereby engaging the locking mechanism 600. In some embodiments, the breading basket may be removed from the breading basin without translating the drive shaft of the drive motor out of the breading basin. For example, the breading basket may include a slot that enables the breading basket to be decoupled from the drive shaft and lifted from the breading basin without requiring translation of the drive shaft. The breading basin, frame, breading basket, and/or the like may include a mechanism to automatically lock the bottom surface of the breading basket as the breading basket is raised from the breading basin.

In some embodiments, the breading basin 401 includes a mechanism, catch, and/or the like that automatically disengages the locking mechanism 600 in response to the breading basket being lowered into the breading basket. For example, the breading basin 401 may include a catch that automatically raises and nests the handle 603 into a lifted position as the breading basket is lowered into the breading basin, thereby raising the plunger 601 out of the void 605 such that the central shaft 303 is free to rotate. The mechanism, catch, and/or the like, that automatically disengages the locking mechanism 600 in response to basket lowering may be the same or different from the element that automatically engages the locking mechanism 600 in response to basket raising.

FIG. 7 shows a perspective view of a portion of an example breading system. As described above, the breading basket 103 may include a void 701 configured to receive a pin of the handle 603 of the breading basket locking mechanism. In receiving the pin of the handle 603, the void 701 may restrain the handle 603 (and connected plunger) against lowering such that the locking mechanism 600 is held in a disengaged configuration.

FIG. 8 shows a perspective view of an example breading basket 103. In some embodiments, the breading basket 103 includes a void 801 that enables insertion and retrieval of a bottom surface 201 (or bottom surface 203) into and out of the breading basket. In some embodiments, the void 801 includes a removable gasket, plug, and/or the like that seals the void 801 during breading. The gasket, plug, and/or the like may be removed during assembly and removal of the bottom surface of the breading basket to facilitate cleaning. In some embodiments, the void 801 receives an end of the central shaft 303 of the bottom surface. In some embodiments, the breading basket 103 includes a second void 802 configured to receive an opposing end of the central shaft 303. In one example, a bottom surface 201 may be lowered into a breading basket 103 by orientating a first end of the central shaft 303 into the void 801 and an opposing second end of the central shaft 303 into the void 802. In various embodiments, at the first end, the central shaft 303 includes a coupling 803 that interfaces with a drive shaft of the drive motor such that rotation of the drive shaft causes corresponding rotation of the central shaft 303 and entire bottom surface of the breading basket. In some embodiments, the coupling 803 includes two-fold rotational symmetry such that the drive shaft may be coupled regardless of the rotational orientation of the bottom surface of the breading basket. Alternatively, in some embodiments, the drive shaft and/or central shaft of the bottom surfaces include one or more magnetic elements such that the drive shaft may be magnetically coupled to the central shaft (e.g., magnetic interaction being used to apply torque from the drive shaft to the central shaft). In some embodiments, the breading basket 103 includes handles 805A, 805B for facilitating carrying of the breading basket by an operator of the breading system.

FIG. 9 shows a right-side view of an example breading basket 103. The right-side view further depicts an example coupling 803 of a central shaft 303 and pin 604 of an example handle 603.

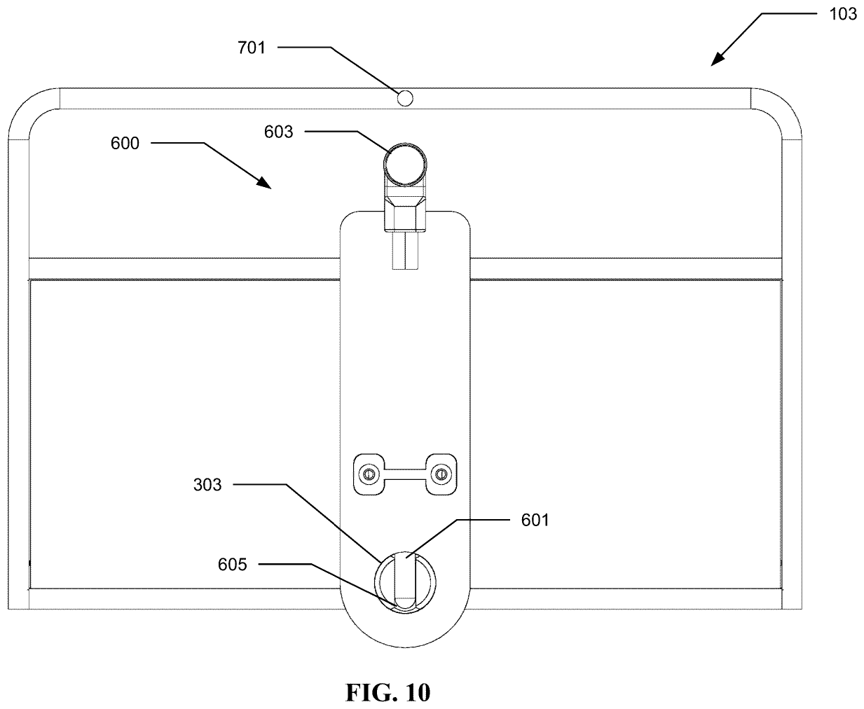

FIG. 10 shows a left-side view of an example breading basket 103. The left-side view further depicts an example void 605 of the central shaft 303 and a plunger 601 of the locking mechanism 600 lowered into the void 605 such that the central shaft 303 is secured against rotation.

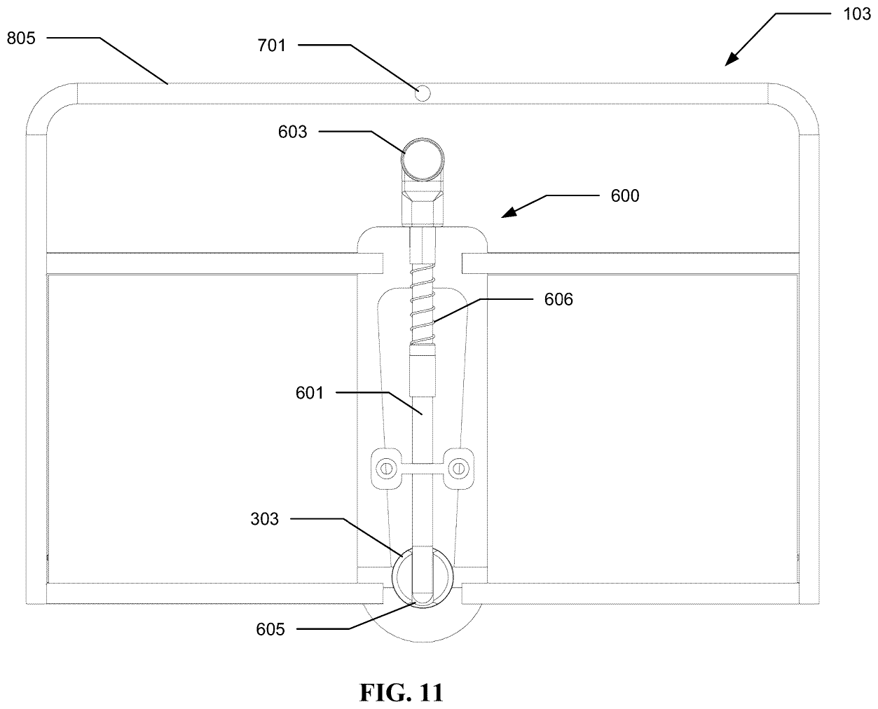

FIG. 11 shows a left-side view of an example breading basket 103. The left-side view further depicts elements of an example locking mechanism 600 including a plunger 601, handle 603, void 605, and spring 606. The left-side view further shows a void 701 of a handle 805 that is configured to receive a pin of the handle 603 such that the locking mechanism 600 is maintained in a disengaged configuration.

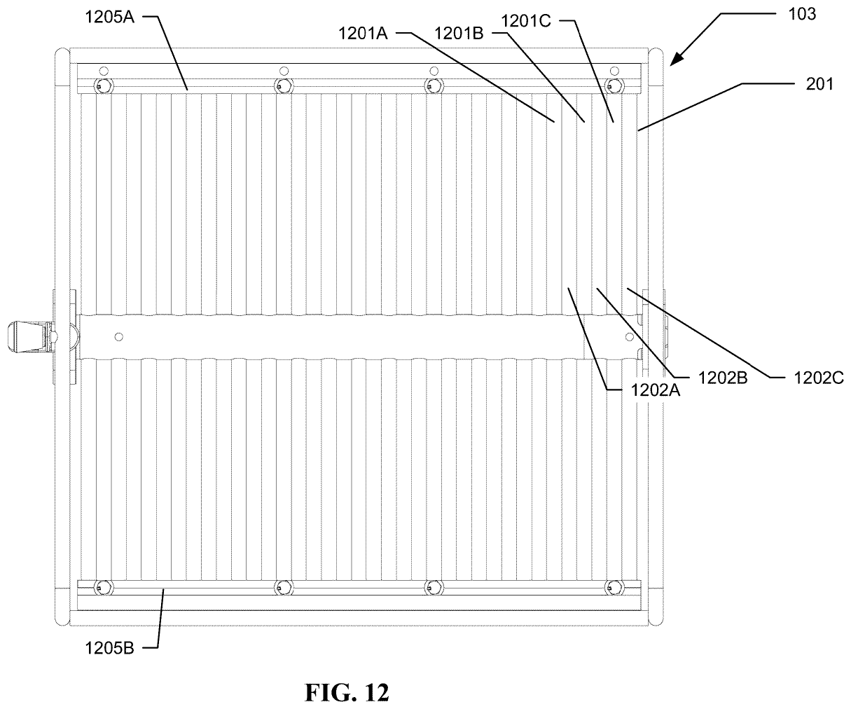

FIG. 12 shows a top view of an example breading basket in accordance with some embodiments of the present disclosure. In various embodiments, the breading basket 103 shown in FIG. 12 includes a bottom surface 201 configured to support and facilitate breading of food products. As shown, the bottom surface 201 may include a plurality of slots 1201A, 1201B, 1201C such that breading compound may pass through the bottom surface 201 and adhere to food products. In various embodiments, the bottom surface 201 enables movement of food products through a volume of breading compound for coating purposes while permitting excess breading compound to pass through the bottom surface 201. In various embodiments, the bottom surface 201 includes a central shaft 303, a first set of rods attached to a first side of the central shaft 303, and a second set of rods attached to a second side of the central shaft 303 opposite the first side. Alternatively, in some embodiments a single set of rods extend through the central shaft 303. In some embodiments, the rods and spacing thereof define slots through which breading compound may pass through the bottom surface 201. For example, a plurality of rods 1202A, 1202B, 1202C may be spaced apart to form slots 1201A, 1201B, 1201C. A separation distance between respective slots may be sized enable movement of the coating compound through the bottom surface 201. In some embodiments, the rods are secured to respective outer plates 1205A, 1205B on opposing sides of the breading basket 103. In some embodiments, the rods, slots, and/or the like are arranged perpendicular to the central shaft 303. Alternatively, in some embodiments, one or more rods, slots, and/or the like are arranged at an offset angle relative to the central shaft 303. In some embodiments, the rods arranged along a single horizontal plane. Alternatively, in some embodiments, one or more rods are arranged at one or more projection angles such that the one or more rods extend into additional horizontal planes. In some embodiments, the bottom surface excludes the central shaft 303. For example, the bottom surface may include a plurality of rods and a frame that surrounds and is connected to the plurality of rods. The frame may include a pin at a first side that is received into a void on a first side of the breading basket, and, on a second side, the frame may include a coupling configured to engage with a drive shaft proximate to an opposing side of the breading basket.

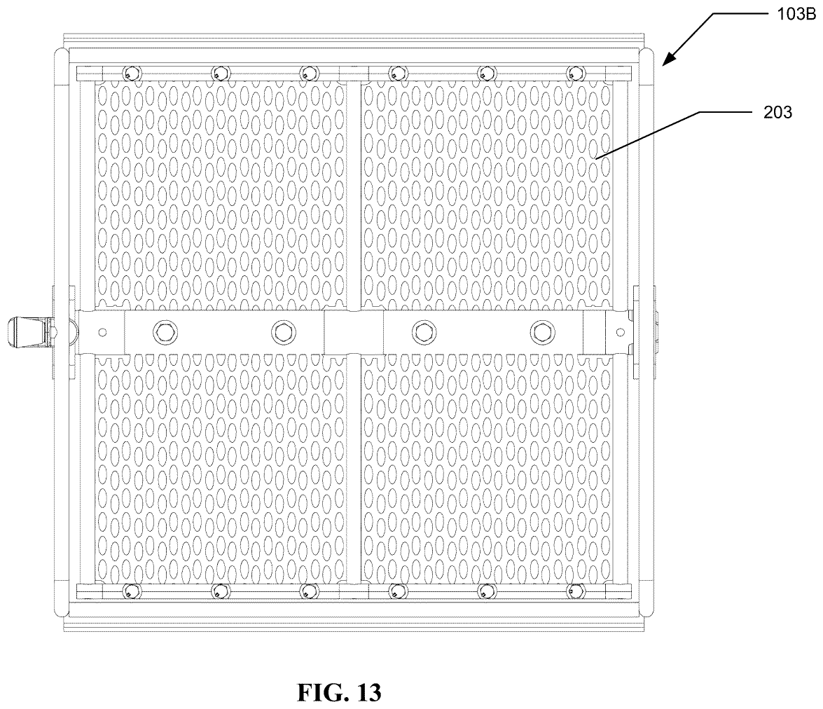

FIG. 13 shows a top view of an example breading basket configured for de-clumping in accordance with some embodiments of the present disclosure. In various embodiments, the breading basket 103 shown in FIG. 13 includes a bottom surface 203 configured for isolation and removal of clumps from a volume of breading compound within a breading basin.

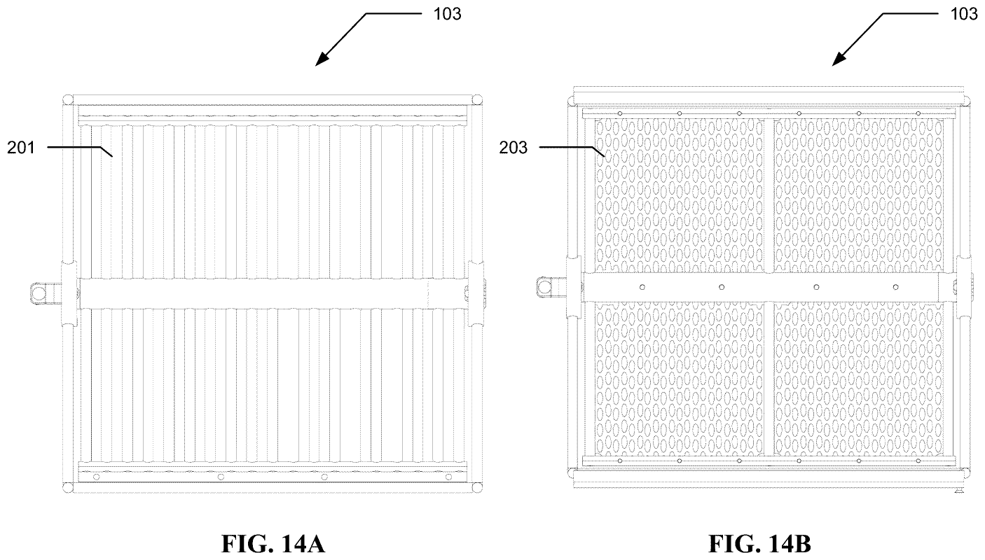

FIG. 14A shows a bottom view of an example breading basket 103.

FIG. 14B shows a bottom view of an example breading basket 103.

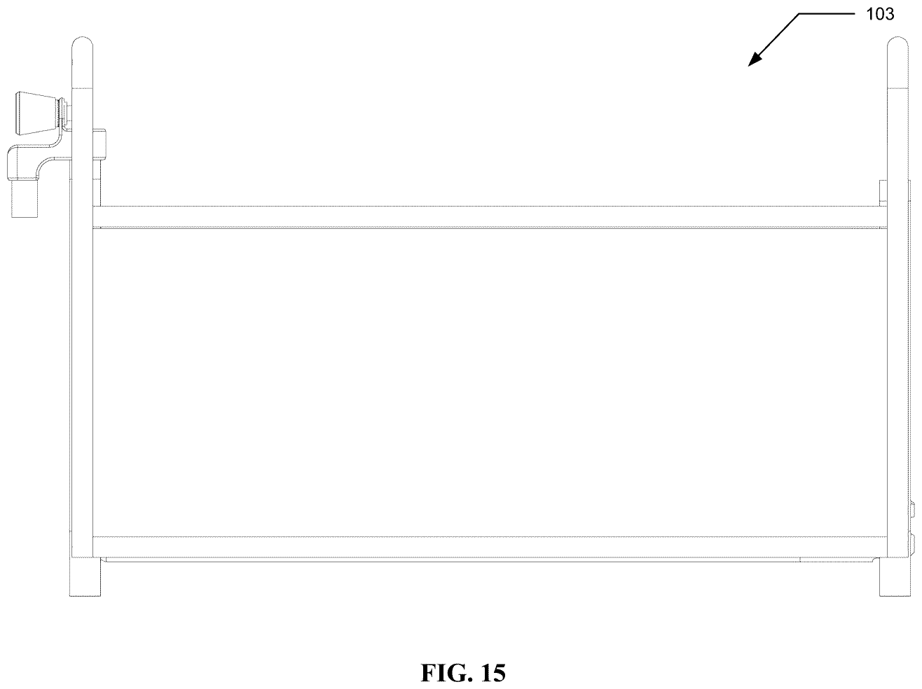

FIG. 15 shows a front view of an example breading basket 103.

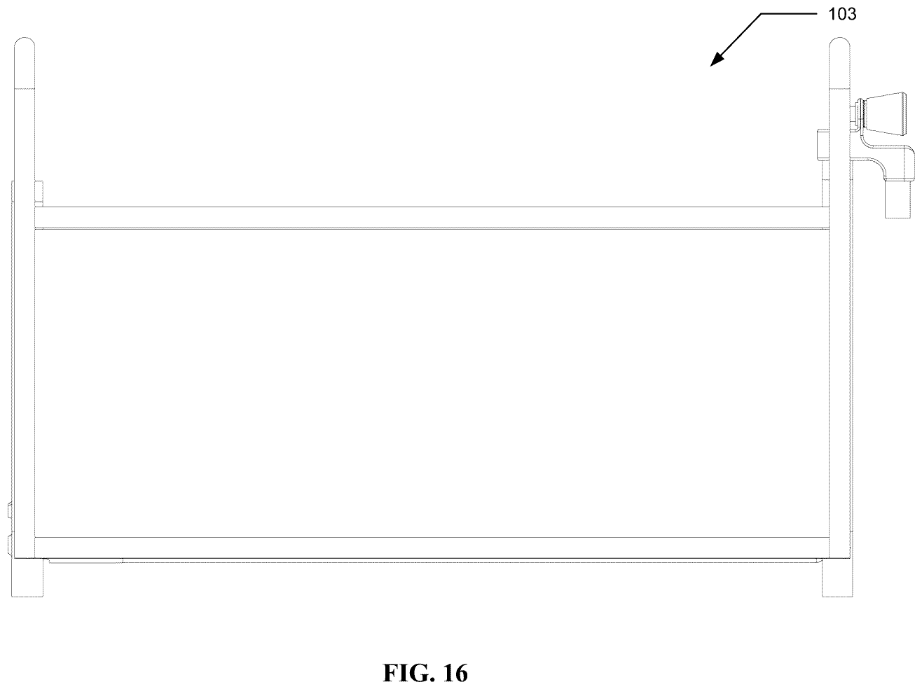

FIG. 16 shows a back view of an example breading basket 103.

FIG. 17 shows an example sequence of inserting a breading basin into a breading system. In some embodiments, a frame 102 is inserted over a base 101. The base 101 may define regions 1701, 1703 for receiving and supporting breading basins. In some embodiments, breading basins 401A, 401B are inserted into regions 1701, 1703, respectively. In some embodiments, the frame 102 includes one or more bushing guides 1705 that interface with pins of a breading basin to properly align the breading basin to the frame 102. FIG. 17 further depicts a void 1707 of the breading basin. In various embodiments, the void 1707 receives a drive shaft of a drive motor such that the drive shaft may be connected to a coupling of a breading basket disposed within the breading basin.

FIG. 18 shows an example sequence of inserting a breading basket into a breading basin. In some embodiments, breading baskets 103A, 103B are inserted into breading basins 401A, 401B, respectively. FIG. 18 illustrates the locking mechanism 600 of the breading basket in an engaged configuration such that the bottom surface of the breading basket is secured against rotation. In various embodiments, the sensor 607 of the frame 102 is contacted by a portion of the locking mechanism 600 such that a connected computing device may determine that the breading basked is secured against rotation. In some embodiments, in response to the locking mechanism 600 being engaged, a linear actuator (not shown) is retracted and/or prevented from extending.

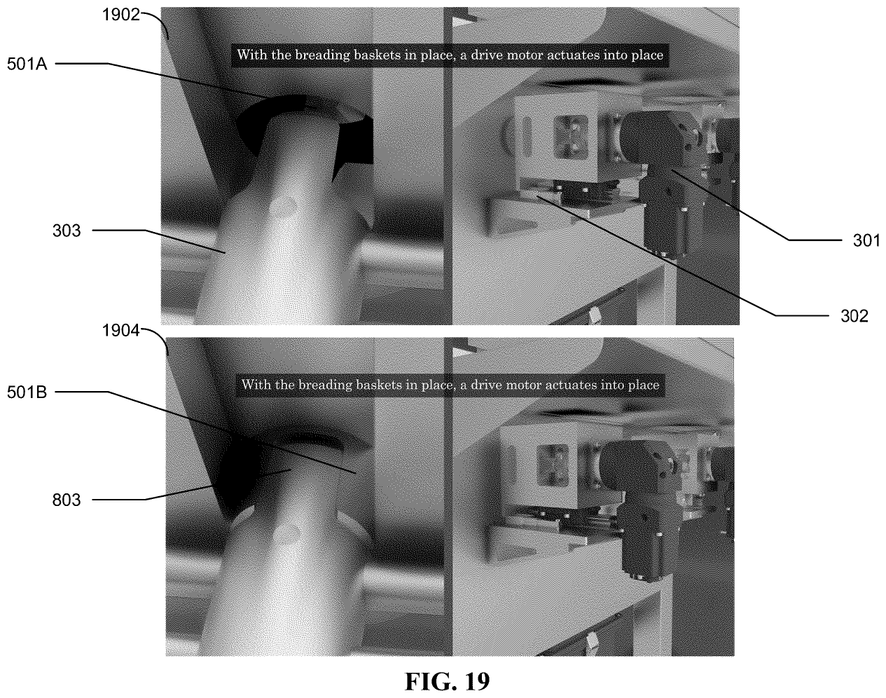

FIG. 19 shows an example sequence of operatively connecting a drive motor to a central shaft of a bottom surface of a breading basket. As illustrated at block 1902, the central shaft 303 and drive shaft 501A are disconnected. In some embodiments, the linear actuator 302 extends such that the drive motor 301 and drive shaft 501A forward translates. As illustrated at block 1904, the forward-translated drive shaft 501B may interface with a coupling 803 of the central shaft 303 such that the drive shaft 501B and central shaft 303 are rotationally linked. For example, following block 1904, the drive motor 301 may be activated to rotate the drive shaft 501B, which may cause a corresponding rotation of the central shaft 303.

FIG. 20 shows an example sequence of breading food products using a breading system. At block 2002, a plurality of washed food products may be disposed within a breading basket (e.g., the breading basket disposed within a breading basin). The locking mechanism of the breading basket may be configured to a disengaged state such that the bottom surface is free to rotate. The central shaft of the bottom surface may be rotationally linked to a drive motor such that rotation of a drive shaft causes rotation of the drive motor. At block 2004, the drive motor may be activated to rotate the drive shaft, thereby causing rotation of the central shaft and bottom surface. As shown at blocks 2006-2012, the rotating bottom surface may drop and push the food products into and through the breading compound within the breading basin.

FIG. 21 shows an example sequence of breading food products using a breading system as described herein.

FIG. 22 shows an example sequence for isolating clumps of breading compound from a breading basin. As shown in blocks 2202-2212 a bottom surface embodying a mesh screen may be rotated through the volume of breading compound in the breading basin. The bottom surface may isolate clumps of breading compound such that the clumps may be extracted from the breading basin by removal of the breading basket.

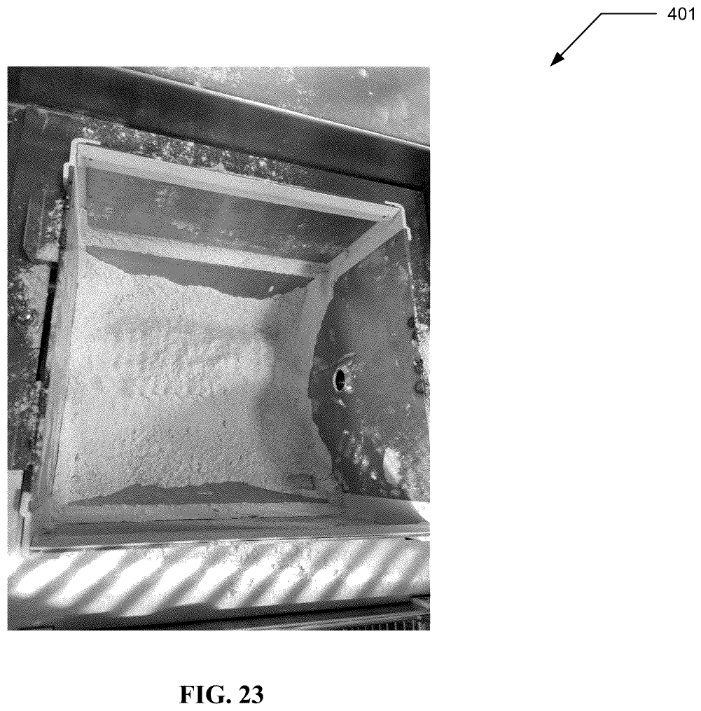

FIG. 23 shows an example breading basin 401.

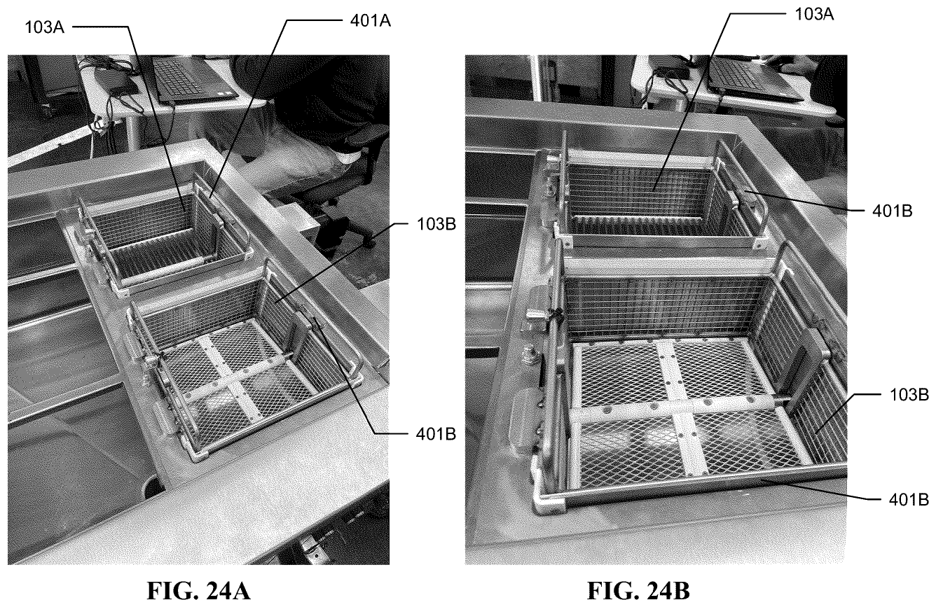

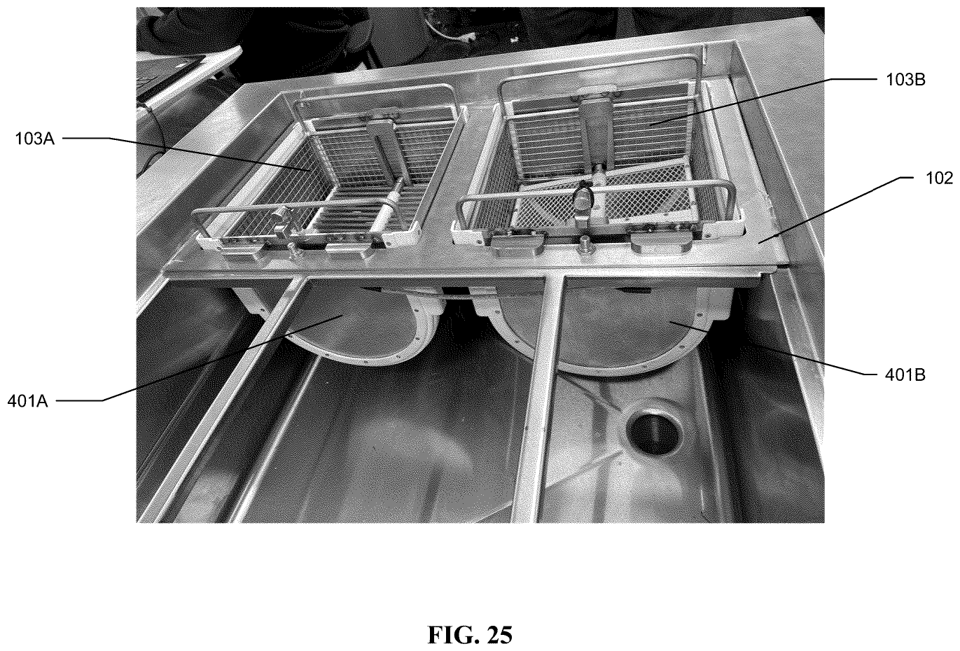

FIGS. 24A, 24B, and 25 show an example frame 102, breading basins 401A, 401B and breading baskets 103A, 103B.

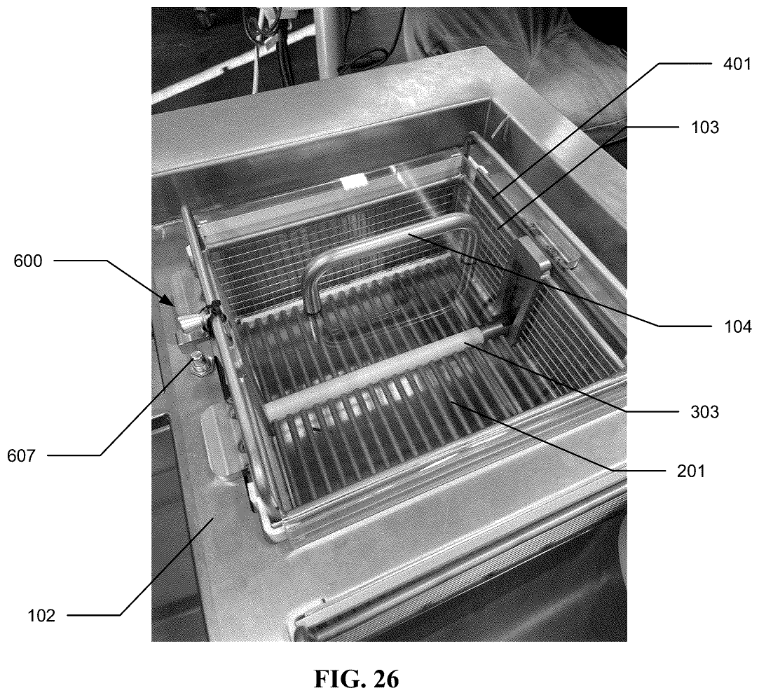

FIG. 26 shows an example frame 102, breading basin 401, and breading basket 103. As shown, a cover 104 may be placed over the breading basket 103 to provide a barrier between the breading basket 103 and an operator. In FIG. 26, the locking mechanism 600 of the breading basket 103 is in a disengaged configuration such that the central shaft 303 of the bottom surface 201 is free to rotate. The sensor 607 may generate a reading indicative of the disengaged configuration of the locking mechanism 600. In response to the reading, a computing device (not shown) may cause a linear actuator to extend such that a drive shaft of a drive motor forward translates and interfaces with the central shaft 303.

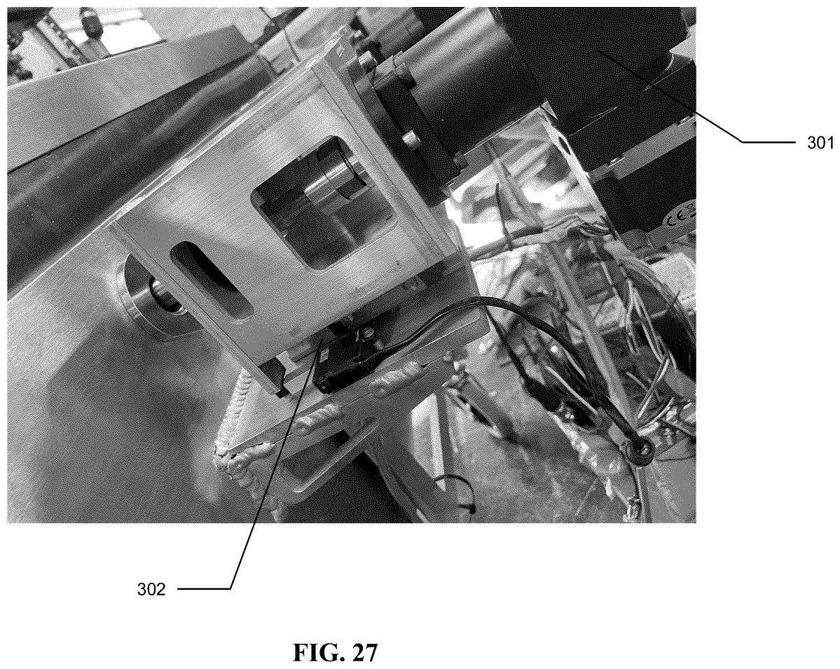

FIG. 27 shows an example drive motor 301 and linear actuator 302.

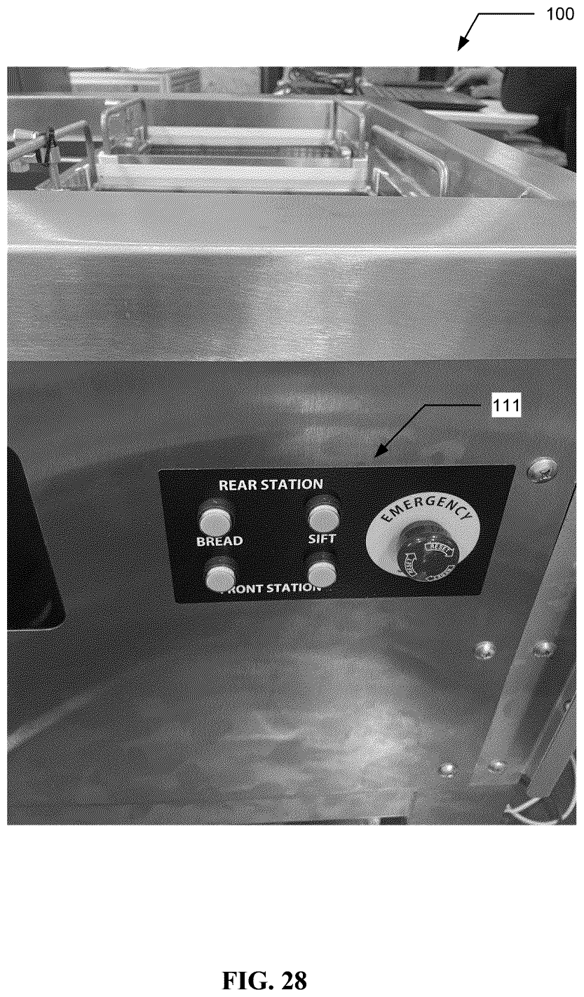

FIG. 28 shows an example control panel 111.

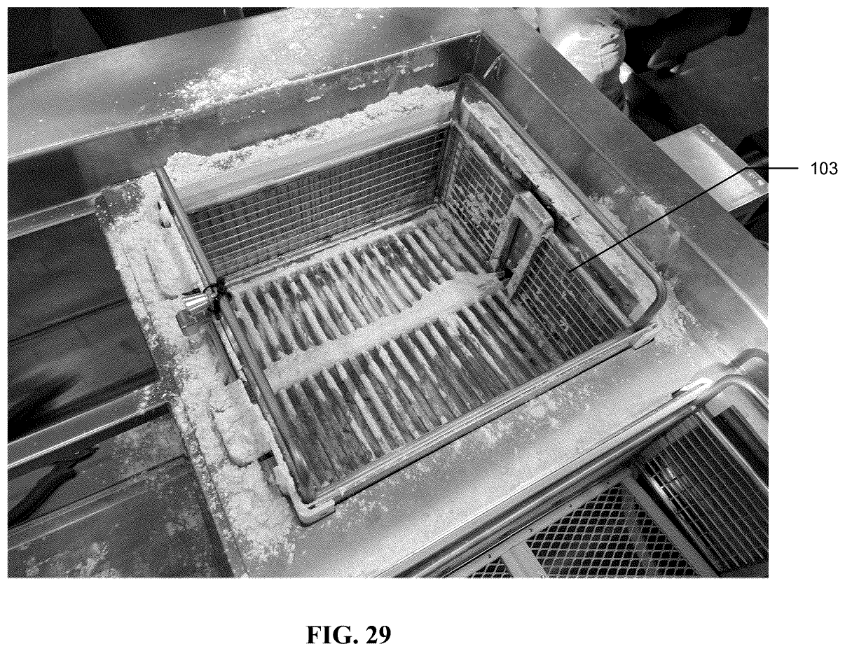

FIG. 29 shows an example breading basket 103.

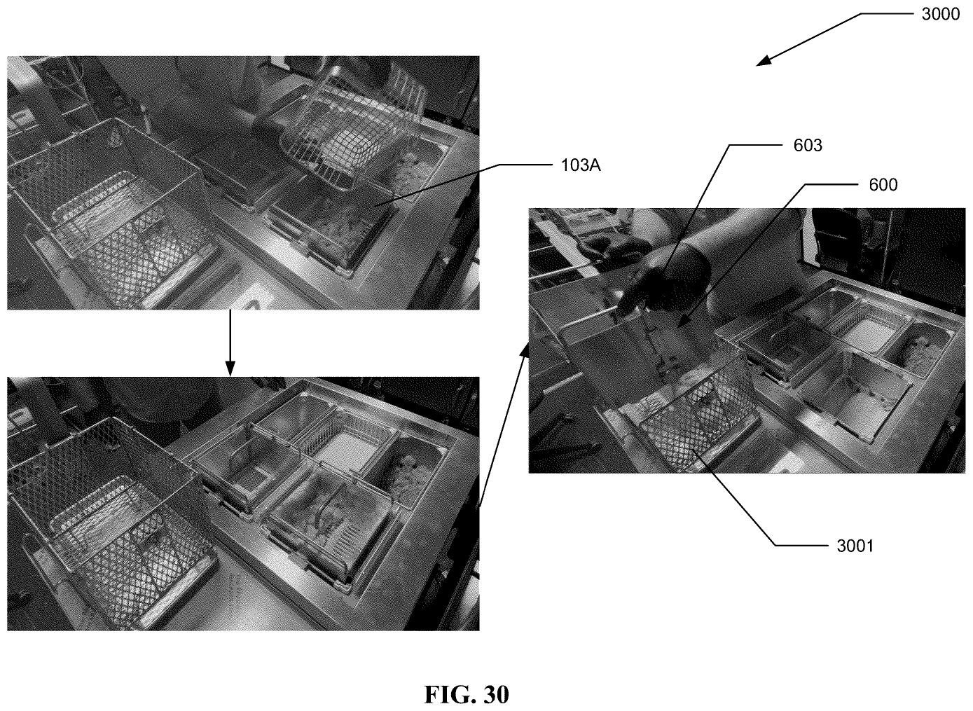

FIG. 30 shows an example breading sequence 3000. In some embodiments, the breading sequence 3000 includes depositing washed food products into a breading basket 103A, breading the food products via rotation of the bottom surface of the breading basket, and releasing the breaded food products into a frying basket 3001. In some embodiments, following breading of the food products, a locking mechanism 600 is engaged via lowering of a handle 603 into the bottom surface such that the bottom surface is secured against rotation. In some embodiments, to release the breaded food products into the frying basket 3001, the locking mechanism 600 is disengaged via raising of the handle 603 such that the bottom surface is able to rotate and drop the breaded food products from the breading basket 103A into the frying basket.

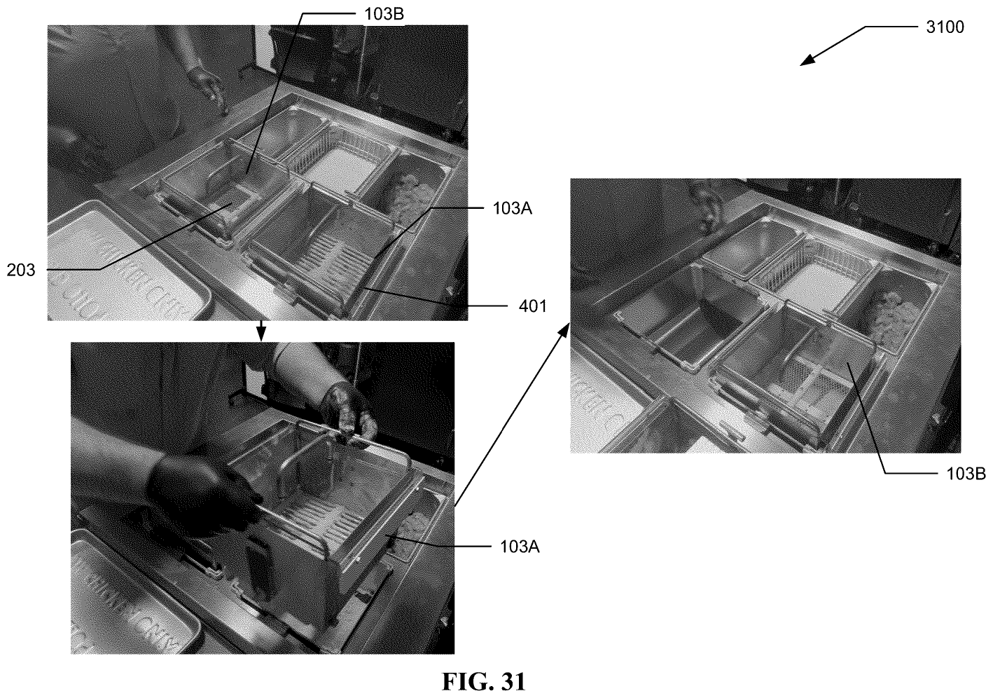

FIG. 31 shows an example sequence 3100 for removing clumps from a volume of breading compound. As shown, a basket 103A configured for breading may be removed from a breading basin 401 containing a volume of breading compound. A basket 103B configured for filtering breading compound may be inserted into the breading basin 401 and rotated through the volume of breading compound to isolate clumps of breading compound above a predetermined particle size. In some embodiments, the breading basket 103B may be removed from the breading basin 401 to extract the clumps of breading compound (e.g., after which the breading basket 103A or another breading basket may be inserted into the breading basin).

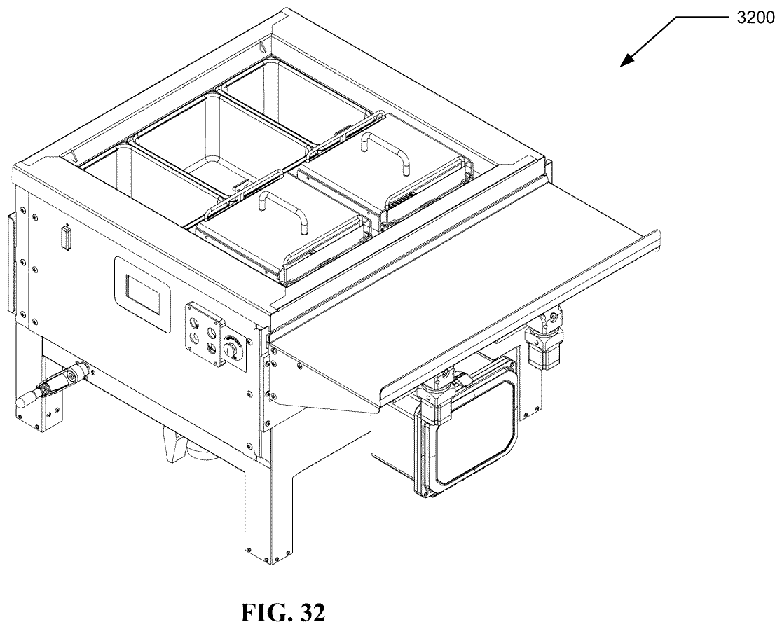

FIG. 32 shows a perspective view of an example breading system 3200 in accordance with some embodiments of the present disclosure.

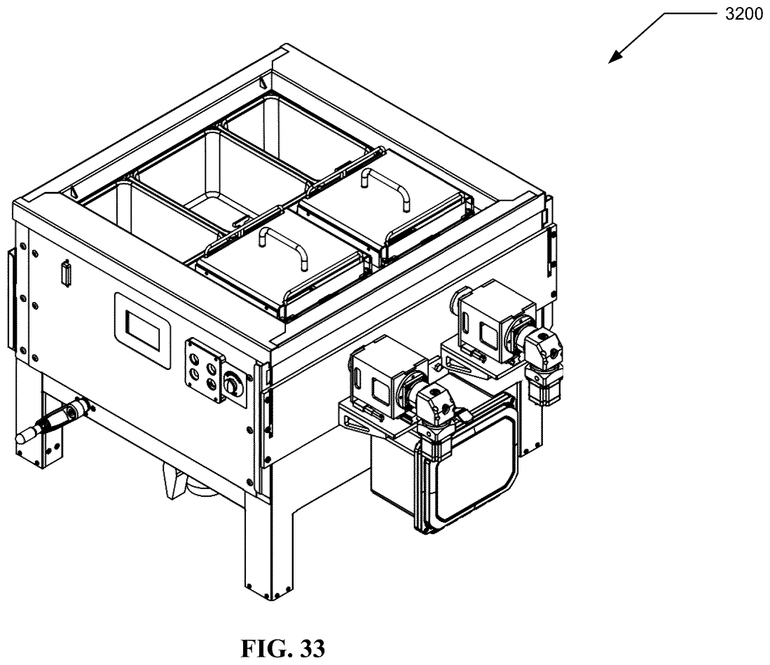

FIG. 33 shows a perspective view of the example breading system 3200 in which a portion of the breading system is omitted to enable illustration of additional aspects.

FIG. 34 shows a perspective view of example breading baskets 103A, 103B in accordance with some embodiments of the present disclosure. In some embodiments, the breading baskets 103A, 103B include locking mechanisms 600A, 600B, respectively. In some embodiments, FIG. 34 illustrates the locking mechanism 600A in a disengaged state and the locking mechanism 600B in an engaged state.

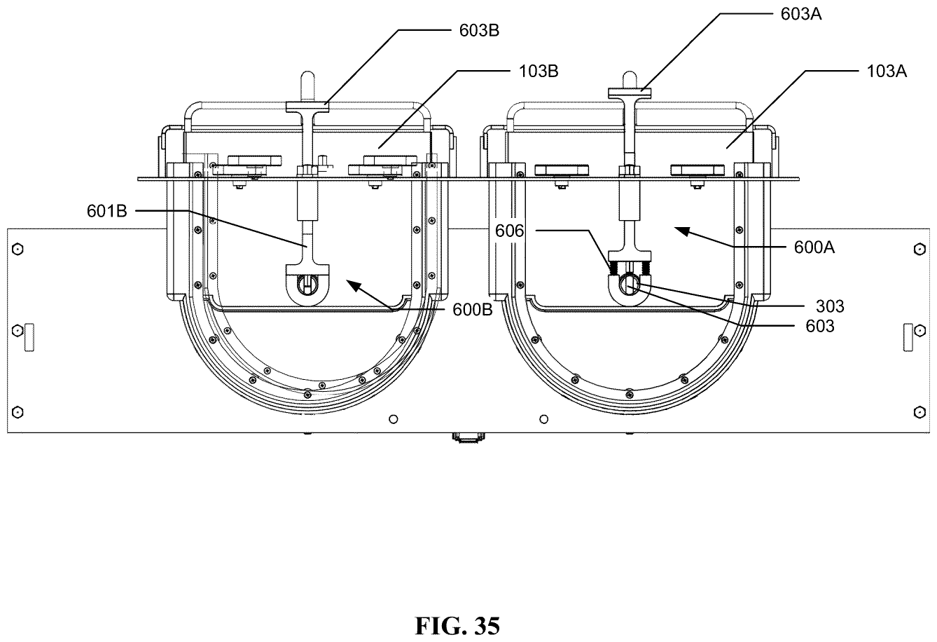

FIG. 35 shows a left-side view of example breading baskets 103A, 103B in accordance with some embodiments of the present disclosure. In some embodiments, the locking mechanism 600A includes a handle 603A that extends along an outer wall of the breading basket 103A and may be raised or lowered to disengage and engage the locking mechanism. For example, FIG. 35 illustrates the handle 603A in a raised position such that a bottom portion of the handle 603A is external to a void 605 of the central shaft 303 of the bottom surface of the breading basket 103A. As another example, FIG. 35 illustrates the handle 603B of the locking mechanism 600B in a lowered position such that a bottom portion of the handle 603B extends into the void of the central shaft, thereby securing the bottom surface of the breading basket 103B against rotation. In some embodiments, the locking mechanisms 600A, 600B include one or more springs 606 configured to oppose raising of the handle 603A, 603B such that the locking mechanism may automatically engage upon the handle being released from a raised position.

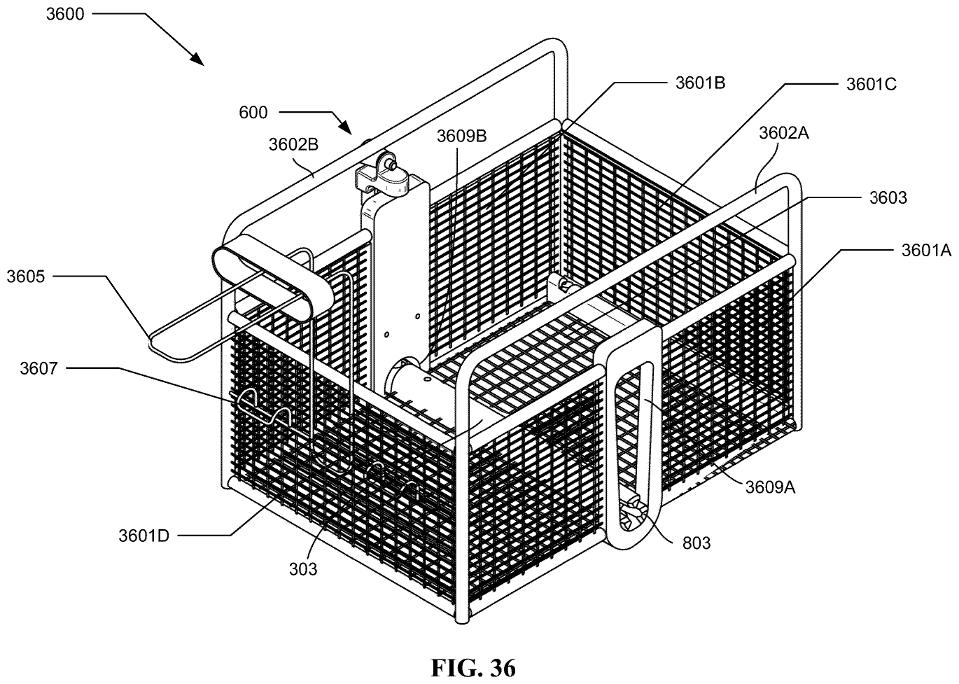

FIG. 36 shows a perspective view of an example frying basket 3600. In various embodiments, the frying basket 3600 includes a plurality of sidewalls 3601A, 3601B, 3601C, 3601D that define a rectangular shape. In some embodiments, the sidewalls 3601A, 3601B, 3601C, 3601D comprise voids such that material may pass through the sidewalls into and out of the rectangular shape. In some embodiments, the sidewalls 3601A, 3601B include handles 3602A, 3602B by which the frying basket 3600 may be lifted, lowered, and carried. Additionally, or alternatively, in some embodiments, the sidewall 3601D includes a handle 3605 by which the frying basket 3600 may be lifted, lowered, and carried. In some embodiments, the sidewall 3601D includes one or more clips 3607 configured to fit over an edge of a basin to maintain the frying basket 3600 in a placed position. For example, the clip 3607 may fit over an edge of a fryer to maintain the frying basket 3600 in a raised position above a volume of heated oil.

In some embodiments, the frying basket 3600 includes a bottom surface 3603 comprising a plurality of voids to enable movement of material through the bottom surface 3603. For example, the voids may enable movement of a liquid, such as oil for frying food products within the frying basket 3600. In various embodiments, the bottom surface 3603 is configured to rotate about an axis extending between the sidewall 3601A and the sidewall 3601B. In some embodiments, the bottom surface 3603 includes a central shaft 303 extending along the axis between the sidewall 3601A and the sidewall 3601B. In some embodiments, the bottom surface 3603 comprises a wireframe extending from opposed sides of the central shaft 303. In some embodiments, the central shaft 303 is configured to rotate about the axis extending between the sidewall 3601A and the sidewall 3601B. In doing so, the central shaft 303 may rotate the bottom surface 3603 about the axis. For example, a weight of food products placed atop the bottom surface 3603 may apply a downward force causing the central shaft 303 and bottom surface 3603 to rotate about the axis. In some embodiments, an end of the central shaft 303 includes a coupling 803 by which a drive shaft (or other rotating means) may be connected to the central shaft 303. In this manner, the central shaft 303 may be rotated via torque applied at the coupling 803.

In some embodiments, the sidewall 3601A includes a void 3609A and the sidewall 3601B includes a void 3609B aligned with the void 3609B along an axis extending between the sidewalls 3601A, 3601B. In some embodiments, the voids 3609A, 3609B are configured to receive respective ends of the central shaft 303. In this manner, the bottom surface 3603 may be connected to the sidewalls 3601A, 3601B such that the bottom surface 3603 is rotatable about the axis extending between the sidewalls 3601A, 3601B. In various embodiments, the frying basket 3600 includes a locking mechanism 600 that may be transitioned to an engaged configuration to secure the central shaft 303 and bottom surface 3603 against rotation. In some embodiments, the locking mechanism 600 may be transitioned to a disengaged configuration such that the central shaft 303 and bottom surface 3603 are rotatable about the axis extending between the sidewalls 3601A, 3601B.

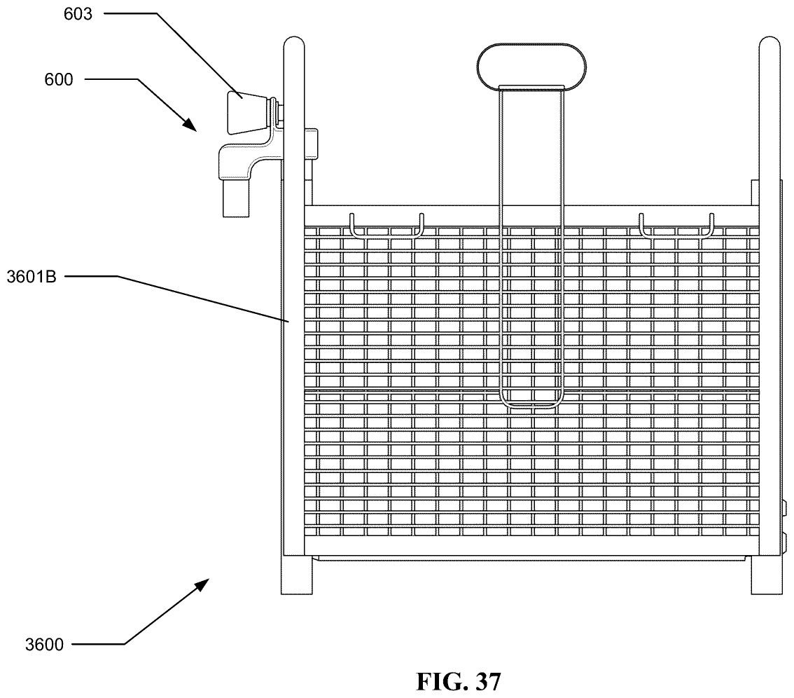

FIG. 37 shows a front view of an example frying basket 3600 including a locking mechanism 600. In some embodiments, the locking mechanism 600 is attached to the sidewall 3601B. FIG. 37 further depicts a member protruding from the locking mechanism 600, which may be manipulated to transition the locking mechanism 600 between the disengaged configuration and the engaged configuration. In some embodiments, the member is a handle 603 that may be manipulated by a user. Alternatively, or additionally, in some embodiments, the member is engaged by an actuator, solenoid, pulley, and/or the like. The member may be transitioned between a raised position and a lowered position to transition the locking mechanism between the disengaged configuration and the engaged configuration. For example, as shown in FIG. 11, the central shaft 303 may include a void 605 and the locking mechanism 600 may include a plunger 601 connected to a handle 603. The handle 603 may be configured to a lowered position to insert the plunger 601 into the void 605. In doing so, the plunger 601 may prevent rotation of the central shaft 303 and, thereby, the bottom surface 3603. The handle 603 may be configured to a raised position to remove the plunger 601 from the void 605, enabling the central shaft 303 and bottom surface 3603 to rotate. Further, the locking mechanism 600 may include a spring 606 configured to bias the handle 603 toward the lowered position (e.g., biasing the locking mechanism 600 to the engaged configuration). In some embodiments, the handle 3602B includes a void configured to receive a pin protruding from the handle 603 (e., in a direction parallel to the axis of rotation of the bottom surface 3603). In doing so, the void and received pin may secure the handle 603 in the raised position and, thereby, maintain the locking mechanism 600 in the disengaged configuration.

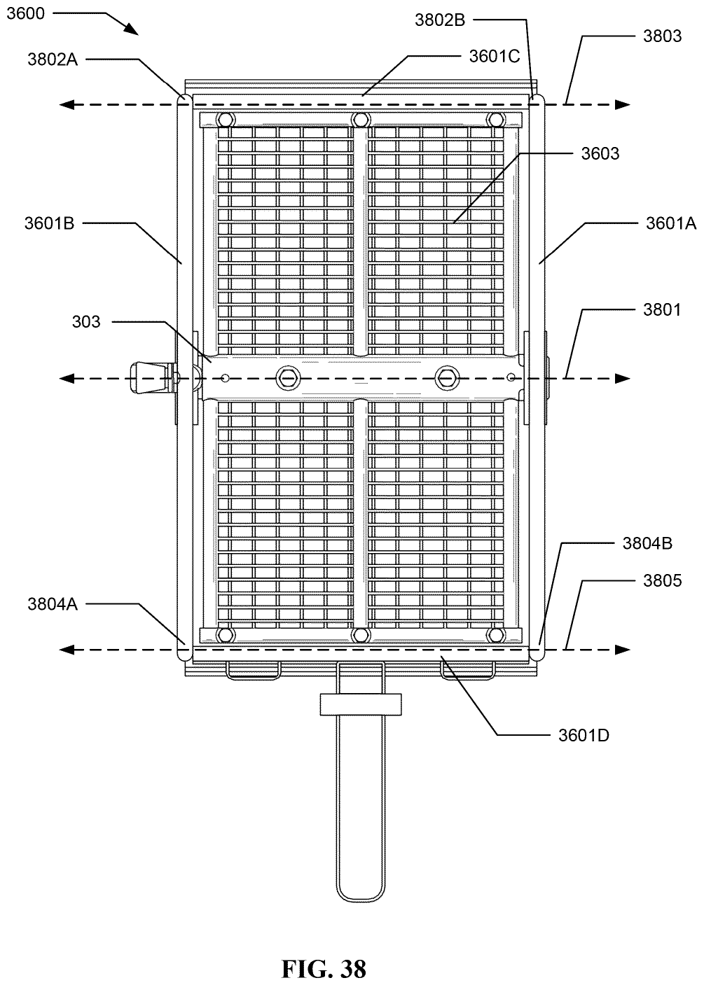

FIG. 38 shows a top view of an example frying basket 3600. In some embodiments, the bottom surface 3603 is configured to rotate about an axis 3801 extending between the sidewalls 3601A, 3601B. In some embodiments, the axis 3801 is centrally aligned between the sidewalls 3601A, 3601B. Alternatively, in some embodiments, the bottom surface 3603 is configured to rotate about an axis 3803 that is positioned at respective ends 3802A, 3802B of the sidewalls 3601A, 3601B and/or along the sidewall 3601C. For example, the bottom surface 3603, central shaft 303, and/or the like may rotate or pivot about the axis 3803 to transition between a substantially lowered position and a substantially raised position. In such contexts, the sidewalls 3601A, 3601B may include respective voids at the at ends 3802A, 3802B. Alternatively, or additionally, in some embodiments, the bottom surface 3603 is configured to rotate about an axis 3805 that extends between respective ends 3804A, 3804B and/or along the sidewall 3601D. For example, the bottom surface 3603, central shaft 303, and/or the like may rotate or pivot about the axis 3805 to transition between a substantially lowered position and a substantially raised position.

In some embodiments, the frying basket 3600 includes one or more additional surfaces positioned above to the bottom surface 3603. The additional surface may be configured to receive an additional plurality of food products. The additional surface may be configured to rotate along an axis that is parallel and superior to the axis of rotation of the bottom surface 3603. For example, the axis of rotation of the additional surface may be parallel to and superior to the axis 3803, the axis 3805, and/or the like. The frying basket 3600 may include a tiered arrangement of surfaces configured to rotate or pivot between various angular orientations (e.g., a substantially lowered vertical orientation, a substantially horizontal orientation, a substantially raised vertical orientation, and/or the like). In this manner, multiple surfaces may be utilized to accommodate food products. Further, if one or more surfaces experience defects (e.g., detachment of a wireframe component, clogged voids, and/or the like), the surface may be rotated to a substantially lowered or raised vertical position, preserving access to and use of the other rotatable surfaces.

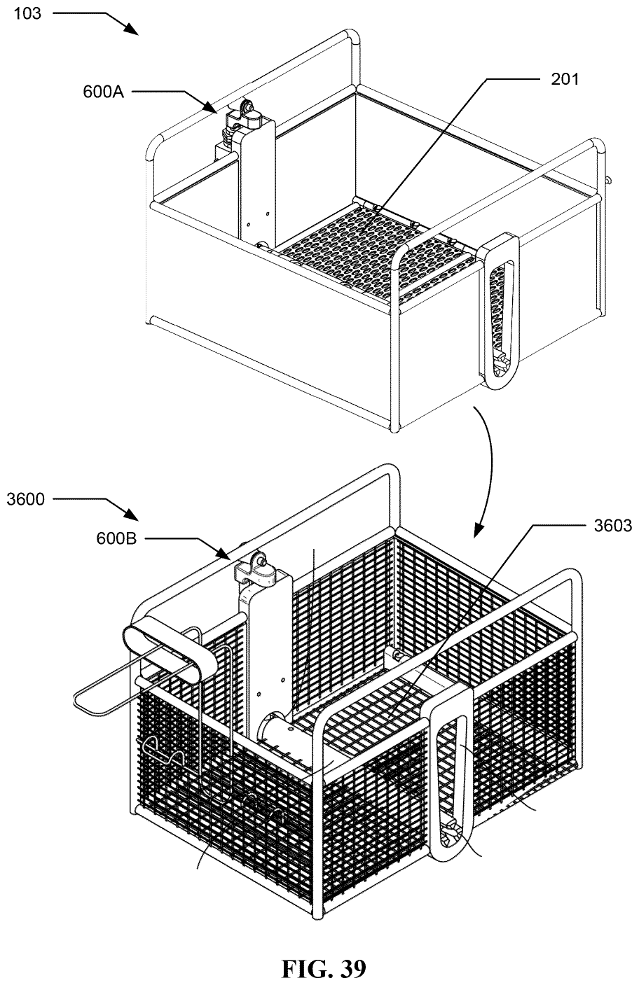

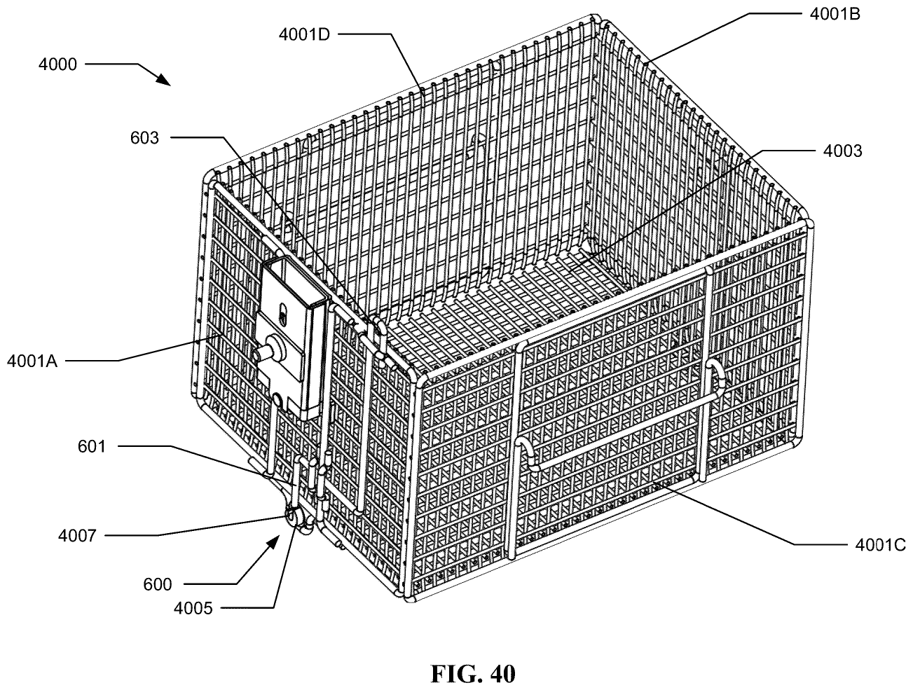

FIG. 39 shows a diagram an example breading basket 103 and an example frying basket 3600. In some embodiments, a plurality of food products may be dispensed from the breading basket 103 into the frying basket 3600 or the frying basket 4000 shown in FIGS. 40-46 and described herein. For example, the frying basket 3600 may be inserted into a basin to transition the locking mechanism 600B of the frying basket 3600 to an engaged configuration, securing the bottom surface 3603 against rotation. A plurality of food products may be dispensed into the breading basket 103 while the breading basket 103 is within a second basin comprising a coating compound. The bottom surface 201 of the breading basket 103 may be rotated to translate the plurality of food products through the coating compound to adhere the coating compound to the food products. Following the breading operation, the locking mechanism 600A of the breading basket 103 may be transitioned to an engaged configuration to prevent rotation of the bottom surface 201.

The breading basket 103, containing coated food products, may be lifted from the second basin and positioned over the first basin and frying basket 3600. The locking mechanism 600A may be transitioned from the engaged configuration to the disengaged configuration to enable rotation of the bottom surface 201. The bottom surface 201 may rotate to dispense the breaded food products into the frying basket 3600, the locking mechanism 600B of the frying basket 3600 being in an engaged configuration to prevent rotation of the bottom surface 3603. The frying basket 3600 may be lowered into a volume of heated oil to fry the food products (e.g., searing and/or carbonizing the breading). The frying basket 3600 may be lifted from the first basin and positioned over a container, tray, and/or the like. The locking mechanism 600B may be transitioned to a disengaged configuration to cause the bottom surface 3603 to rotate under the weight of the fried food products. The rotation of the bottom surface 3603 may cause the fried food products to dispense from the frying basket 3600 into or onto the container, tray, and/or the like. The frying basket 3600 may be reinserted into the first basin to re-engage the locking mechanism 600B and configure the frying basket 3600 to receive additional breaded food products.

FIG. 40 shows a perspective view of an example frying basket 4000. In various embodiments, the frying basket 4000 includes a plurality of sidewalls 4001A, 4001B, 4001C, 4001D that define a generally rectangular shape. In some embodiments, frying basket 4000 includes a bottom surface 4003 configured to rotate along an axis extending between the sidewalls 4001A, 4001B. The bottom surface 4003 may hold a plurality of food products. For example, a plurality of breaded food products may be dispensed from a basket 103 (FIG. 1) onto the bottom surface 4003. In various embodiments, the sidewalls 4001A, 4001B, 4001C, 4001D and bottom surface 4003 include a plurality of voids to pass material through the rectangular shape. For example, a heated oil for frying food products may be passed into the rectangular shape via the plurality of voids. The cooking oil may include peanut oil, canola oil, olive oil, coconut oil, sesame oil, grapeseed oil, corn oil, avocado oil, sunflower oil, soybean oil, vegetable oil, safflower oil, rice bran oil, cottonseed oil, ghee, palm oil, butter, lard, almond oil, flaxseed oil, blended oil, and/or the like.

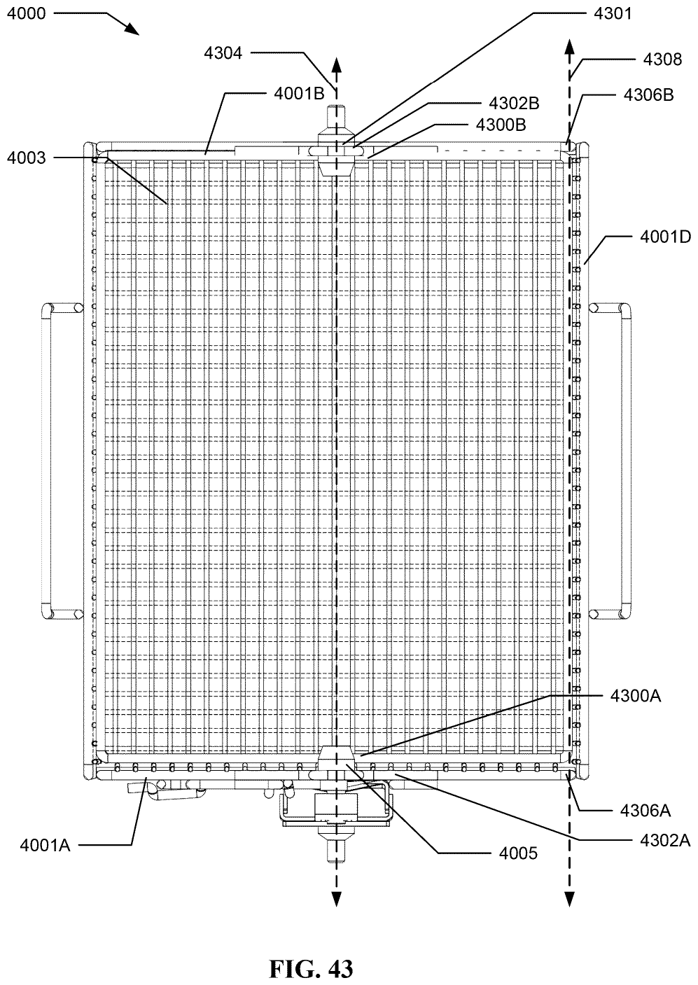

In some embodiments, the frying basket 4000 includes a locking mechanism 600 configured to transition between an engaged configuration and a disengaged configuration to control rotation of the bottom surface 4003. In the engaged configuration, the locking mechanism 600 may prevent rotation of the bottom surface 4003 about the axis extending between the sidewalls 4001A, 4001B. In the disengaged configuration, the bottom surface 4003 may freely rotate about the axis. In some embodiments, the bottom surface 4003 includes a first member 4005 that protrudes into the sidewall 4001A. As further shown in FIG. 43, the bottom surface 4003 may include a second member 4301 that protrudes into the sidewall 4001B. The first member 4005 and the second member 4301 may include circular shapes enabling the bottom surface 4003 to rotate about an axis extending between the sidewalls 4001A, 4001B.

In some embodiments, the locking mechanism 600 includes a plunger 601 and a handle 603 connected to the plunger 601. In various embodiments, the first member 4005 includes a slot 4007 configured to receive the plunger 601 when the locking mechanism 600 is in the engaged configuration. In doing so, the slot 4007 and inserted plunger 601 may prevent rotation of the bottom surface 4003. A handle 603 may be connected to the plunger 601 and extend above the sidewall 4001A. The handle 603 may be configurable between a raised position and a lowered position to raise and lower the plunger 601 out of and into the slot 4007. In this manner, the handle 603 may be transitioned between the raised position and the lowered position to transition the locking mechanism 600 between the disengaged configuration and the engaged configuration. In some embodiments, the locking mechanism 600 includes a spring, magnet, tension mechanism, and/or other biasing element configured to apply a downward force to the handle 603, plunger 601, and/or the like to bias the locking mechanism 600 toward the engaged configuration.

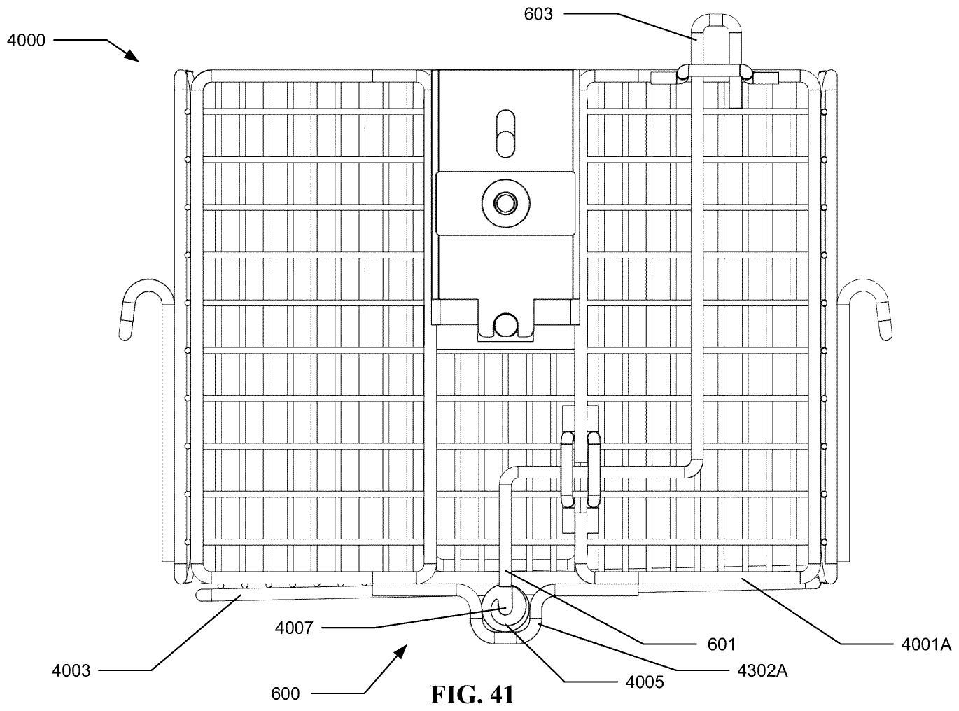

FIG. 41 shows a left-side view of an example frying basket 4000. In some embodiments, the sidewall 4001A includes a bracket 4302A configured to receive the first member 4005 of the bottom surface 4003. The bracket 4302A and first member 4005 may vertically align the slot 4007 with the plunger 601. In this manner, the plunger 601 may be lowered and raised into and out of the slot 4007.

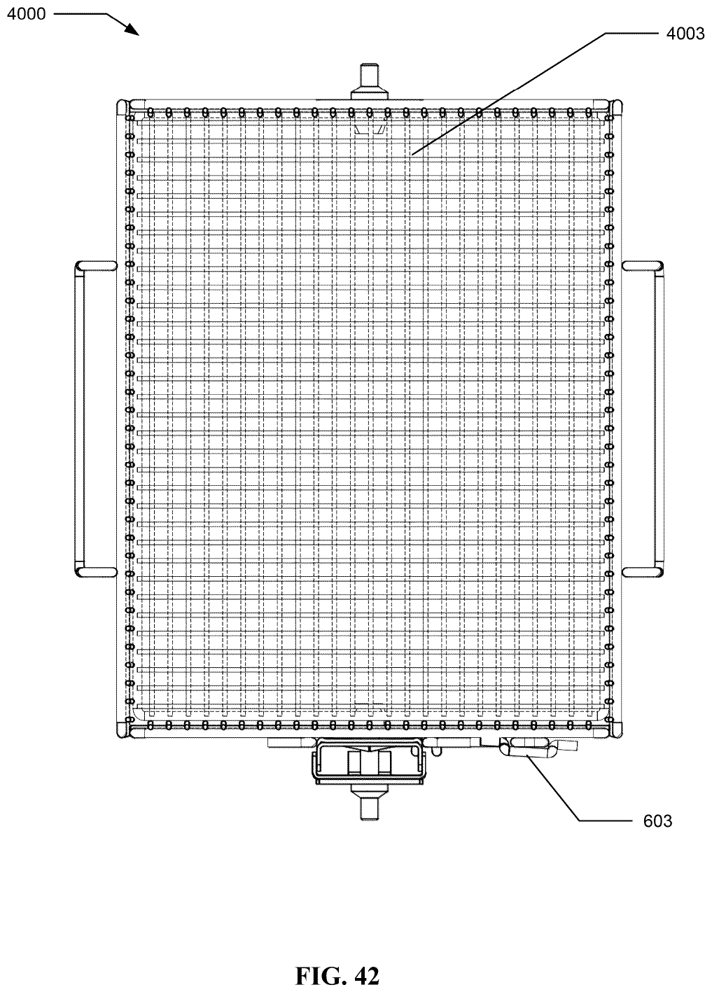

FIG. 42 shows a top view of an example frying basket 4000 including the bottom surface 4003 and handle 603 of the locking mechanism 600.

FIG. 43 shows a bottom view of an example frying basket 4000. In some embodiments, the first member 4005 protrudes from a first end 4300A of the bottom surface 4003 into the bracket 4302A of the sidewall 4001A. In some embodiments, the second member 4301 protrudes from a second end 4300B of the bottom surface 4003 into the bracket 4302B of the sidewall 4001B. In this manner, the bottom surface 4003 may rotate about an axis 4304 extending between the sidewalls 4001A, 4001B. In some embodiments, the brackets 4302A, 4302B are centrally aligned along the sidewalls 4001A, 4001B. Alternatively, in some embodiments, the brackets 4302A, 4302B are positioned at respective ends 4306A, 4306B of the sidewalls 4001A, 4001B. In such contexts, the bottom surface 4003 may rotate about an axis 4308 extending substantially in alignment with the sidewall 4001D. In this manner, the bottom surface 4003 may be configured to rotate or pivot downward and away from the interior volume of the frying basket 4000.

In some embodiments, the frying basket 4000 includes one or more surfaces above the bottom surface 4003. The additional surface may be configured to hold an additional plurality of food products. In some embodiments, the additional surface is configured to rotate or pivot between various angular positions. For example, the additional surface may rotate between a substantially horizontal position, a substantially lowered vertical position, a substantially raised vertical position, and/or the like. In some embodiments, the additional surface is configured to pivot about an axis extending between the ends 4306A, 4306B of the sidewalls 4001A, 4001B. For example, the axis of rotation of the additional surface may be parallel to the axis of rotation of the bottom surface 4003. In some embodiments, the axis of rotation of the bottom surface 4003 (“first axis”) is positioned along a vertical plane extending parallel to the sidewall 4001C or the sidewall 4001D. In some embodiments, the axis of rotation of the additional surface is configured to rotate about a second axis that is parallel to the first axis and positioned above the first axis on the vertical plane.

In some embodiments, the additional surface includes a first coupling member and a second coupling member that protrude from opposite ends of the surface. In some embodiments, the sidewalls 4001A, 4001B include coupling slots configured to receive the first coupling member and the second coupling member, respectively. For example, the first coupling member may protrude into the first coupling slot, and the second coupling member may protrude into the second coupling slot. In various embodiments, the coupling slots and coupling members enable the additional surface to rotate or pivot between the various angular orientations. In some aspects the coupling members and coupling slots are configured in accordance with one or more embodiments described in U.S. patent application Ser. No. 18/193,255, filed Mar. 30, 2023, entitled “REMOVABLE TIERED BASKET,” the disclosure of which is incorporated herein by reference in its entirety.

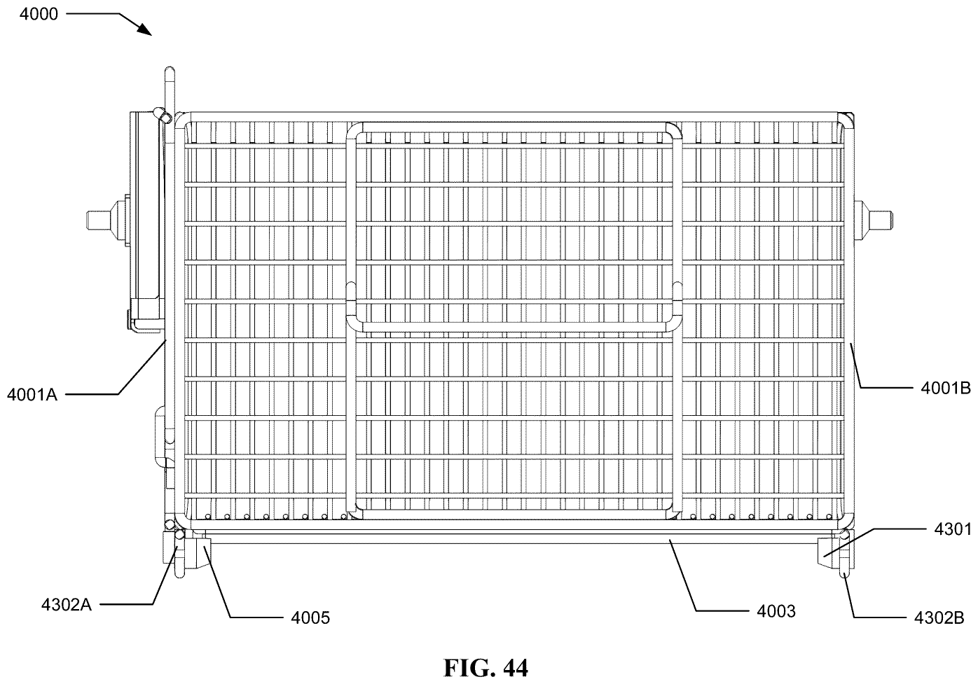

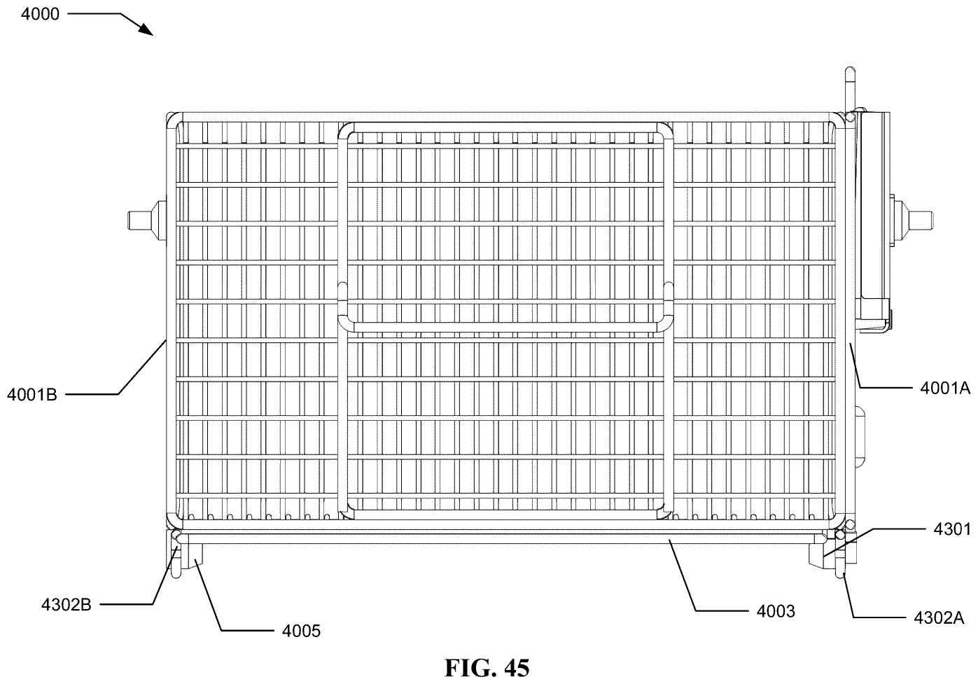

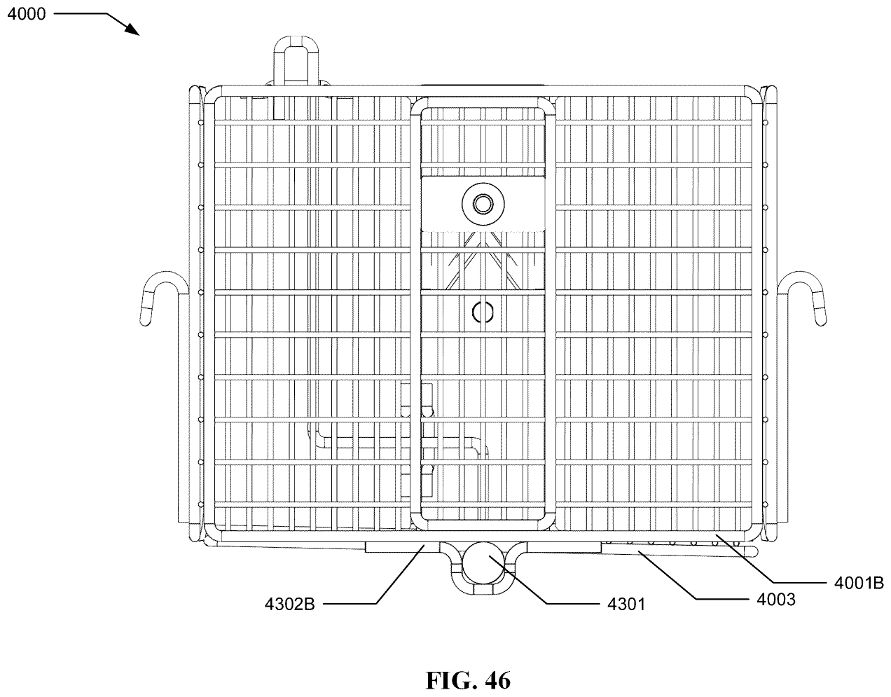

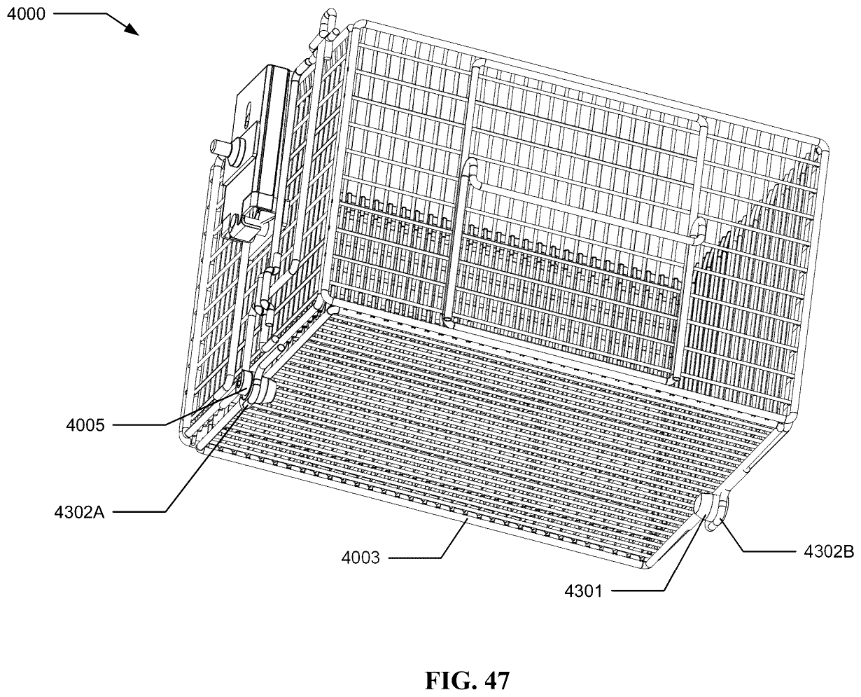

FIG. 44 shows a front view of an example frying basket 4000. As depicted, the first member 4005 may protrude into the bracket 4302A of the sidewall 4001A, and the second member 4301 may protrude into the bracket 4302B of the sidewall 4001B. Alternatively, in some embodiments, the bottom surface 4003 includes a first bracket and a second bracket at opposed ends, and the sidewalls 4001A, 4001B include members that protrude orthogonally into the first bracket and second bracket, respectively. FIG. 45 shows a back view of an example frying basket 4000 including the bottom surface 4003, sidewalls 4001A, 4001B, brackets 4302A, 4302B, and first and second members 4005, 4301. FIG. 46 shows a back view of an example frying basket 4000. As depicted, the bracket 4302B may protrude from the sidewall 4001B and receive the second member 4301. FIG. 47 shows a bottom perspective view of an example frying basket 4000. As shown, the first member 4005 and the second member 4301 may protrude from the bottom surface 4003 into the first bracket 4302A and the second bracket 4302B, respectively. While various aspects have been described, additional aspects, features, and

methodologies of the claimed apparatuses will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

1. A system for holding food products, comprising:
a plurality of sidewalls defining a rectangular shape;
a first void within a first sidewall;
a second void within a second sidewall opposite the first sidewall, the second void and the first void aligned along an axis extending across the first sidewall and the second sidewall;
a bottom surface configured to hold a plurality of food products within the rectangular shape and comprising:
a first end and a second end opposite the first end; and
a first member protruding from the first end into the first void and a second member protruding from the second end into the second void such that the bottom surface is rotatable about the axis to dispense the plurality of food products form the rectangular shape;
at least one of the first sidewall or the second sidewall comprising a locking mechanism configured to transition between an engaged configuration and a disengaged configuration, wherein:
in the engaged configuration, the locking mechanism prevents rotation of the bottom surface about the axis; and
at least one handle configured to transition the locking mechanism between the engaged configuration and the disengaged configuration.

2. The system of claim 1, wherein:
the first sidewall comprises a first bracket comprising the first void; and
the second sidewall comprises a second bracket comprising the second void.

3. The system of claim 1, wherein:
the first member comprises a slot;
the locking mechanism comprises:
a plunger configured to transition between a raised position and a lowered position to transition the locking mechanism between the disengaged configuration and the engaged configuration, wherein:
in the lowered position, the slot receives the plunger; and
in the raised position, the plunger is external to the slot; and
the at least one handle is configured to transition the plunger between the raised position and the lowered position.

4. The system of claim 3, wherein:
the locking mechanism further comprises a spring configured to apply a force to the plunger to bias the plunger toward the lowered position.

5. The system of claim 3, wherein:
the at least one handle extends above the plurality of sidewalls.

6. The system of claim 3, further comprising:
a second handle extending along the first sidewall; and
a third handle extending along the second sidewall, wherein:
the second handle and the third handle extend above the plurality of sidewalls.

7. The system of claim 6, further comprising:
a pin extending from the at least one handle along the axis, wherein:
at least one of the second handle or the third handle comprises a void configured to receive the pin to maintain the at least one handle in the raised position.

8. The system of claim 1, wherein:
the axis is centrally aligned to the first sidewall and the second sidewall.

9. The system of claim 1, wherein:
at least the bottom surface comprise a plurality of voids to enable movement of a material through the rectangular shape.

10. The system of claim 9, wherein:
at least a subset of the plurality of sidewalls comprise voids to enable movement of a material through the rectangular shape.

11. The system of claim 1, further comprising:
a central shaft extending along the bottom surface, wherein the first member and the second member protrude from opposed ends of the central shaft.

12. The system of claim 11, further comprising:
a drive motor comprising a drive shaft, wherein:
the second member comprises a coupling configured to receive a drive shaft to rotationally couple the bottom surface to the drive motor.

13. The system of claim 1, wherein:
the bottom surface comprises a plurality of slots spaced apart from one another; and
a separation distance between respective slots is sized to enable movement of a breading compound through the bottom surface.

14. The system of claim 13, wherein:
the bottom surface comprises:
a plurality of rods defining the plurality of slots.

15. The system of claim 14, wherein:
a perimeter of the bottom surface comprises a rubberized gasket.

16. The system of claim 13, wherein:
the breading compound comprises at least one of flour, powdered sugar, paprika, black pepper, chili powder, salt, or baking powder.

17. A system for holding food products, comprising:
a basket comprising a bottom surface extending between a first sidewall and a second sidewall of the basket;
the bottom surface being rotatable about a first axis extending between the first sidewall and the second sidewall and configured to hold a plurality of food products, wherein the bottom surface comprises:
a plurality of voids sized to pass material through the bottom surface and oppose movement of the plurality of food products through the bottom surface;
a locking mechanism configured to prevent rotation of the bottom surface about the first axis in an engaged configuration; and
a member configured to transition the locking mechanism from the engaged configuration to a disengaged configuration to enable rotation of the bottom surface about the first axis.

18. The system of claim 17, wherein:
the first axis is positioned along a vertical plane extending parallel to a third sidewall of the basket, the third sidewall being perpendicular to the first sidewall and the second sidewall;
the first sidewall comprises a first coupling slot;
the second sidewall comprises a second coupling slot positioned opposite the first coupling slot along a second axis, the second axis positioned above the first axis on the vertical plane; and
above the bottom surface, the basket further comprises:
a second surface configured to accommodate an additional plurality of food products; and
the second surface comprising a first coupling member protruding from the second surface into the first coupling slot and a second member protruding from the second surface into the second coupling slot, wherein:
the first coupling slot, the second coupling slot, the first coupling member, and the second coupling slot are configured to enable the second surface to pivot about the second axis between at least a substantially lowered vertical position and a substantially horizontal position.

19. A method for frying food products, comprising:
inserting a first basket into a basin to engage a locking mechanism of a first basket, the locking mechanism configured to prevent rotation of a bottom surface of the first basket when engaged;
disengaging a locking mechanism of a second basket to enable rotation of a bottom surface of the second basket, the second basket comprising a plurality of food products; and
rotating the bottom surface of second basket to dispense the plurality of food products from the second basket into the first basket, the first basket comprising a plurality of voids to pass a material through the first basket.

20. The method of claim 19, further comprising:
passing at least one heated oil from the basin into the first basket to fry the plurality of food products;
removing the first basket from the basin;
disengaging the locking mechanism of the first basket to enable rotation of the bottom surface of the first basket; and
rotating the bottom surface of the first basket to dispense the plurality of food products out of the first basket.
